(19) United States
(12) Patent Application Publication
(10) Pub. No.: US 2021/0070337 A1
(43) Pub. Date: Mar. 11, 2021

(54) HAND TRUCK TO LADDER DOLLY ADAPTOR

(71) Applicant: Frank Randolph Bowen, III, Davidson, NC (US)

(72) Inventor: Frank Randolph Bowen, III, Davidson, NC (US)

(21) Appl. No.: 17/001,183

(22) Filed: Aug. 24, 2020

Related U.S. Application Data
(60) Provisional application No. 62/897,575, filed on Sep. 9, 2019.

(51) Int. Cl. B62B 1/26; B62B 1/12; B62B 1/14; B62B 1/20

(52) U.S. Cl. CPC B62B 1/262; B62B 1/125; B62B 2202/48; B62B 1/20; B62B 1/142

(57) ABSTRACT

Adapter apparatus for transporting a ladder with a hand truck of the type having wheels and a laterally extending toe plate for supporting an item thereon is provided. The apparatus includes a ladder support configured for receiving a portion of a ladder thereof and at least one hand truck attachment. A first end of the at least one hand truck attachment is coupled to the ladder support. A second opposing end of the at least one hand truck attachment is configured for securely engaging a toe plate of a hand truck. At least a portion of a weight of the ladder is transferred onto the toe plate of the hand truck when the ladder is transported on the hand truck with the ladder support contacting the ladder thereof.

### CROSS-REFERENCE TO RELATED APPLICATIONS

This application claims priority to U.S. Provisional Patent Application No. 62/897,575 filed on Sep. 9, 2019, the entire contents of which are incorporated by reference herein.

### TECHNICAL FIELD

The presently disclosed subject matter relates generally to a ladder transporting mechanism, and in particular to an adaptor for use in conjunction with a hand truck for transporting ladders.

### BACKGROUND

Ladders can be too large or too cumbersome for a single individual to carry easily from place-to-place and without potential for injury, as for example, from its storage place to a work site or one work site to another. Some of these ladders use caddies, dollies, or wheeled attachments to facilitate transport by a single person. However, movable, and retractable casters add weight, size, and cost to the ladder assemblies. They also require that the assembly have a large footprint which increases the storage space needed. The casters and wheels of such assemblies are not easily transferrable to another ladder, adding to the total cost of ladder inventories needed by maintenance organizations. Because of the need to have the ladder's legs rest securely on a supporting surface, a great deal of attention must be paid to the security of any retraction mechanism.

Firefighters are limited in the amount of equipment they can carry on the truck as well as the amount they carry from the truck to the fire. Fire trucks are often parked a great distance from the fire due to safety reasons or because of crowded city streets, forcing the fire fighters to walk a long distance carrying their ladder and other equipment. Currently when a fire fighter arrives at the scene, the fire fighter typically first loads a ladder on a ladder dolly, then stacks other equipment on top of the ladder before heading to the final location.

It would be beneficial to provide a transport mechanism for assisting a person in moving a ladder from place-to-place wherein the transport mechanism that does not interfere with the safe and efficient transport, deployment and use of the ladder.

### SUMMARY

This summary is provided to introduce in a simplified form concepts that are further described in the following detailed descriptions. This summary is not intended to identify key features or essential features of the claimed subject matter, nor is it to be construed as limiting the scope of the claimed subject matter.

An adapter apparatus for transporting a ladder with a hand truck of the type having wheels and a laterally extending toe plate for supporting an item thereon is provided. The apparatus includes a ladder support configured for receiving a portion of a ladder thereof, and at least one hand truck attachment configured for engageably receiving the toe plate of the hand truck. A first end of the at least one hand truck attachment is coupled to the ladder support, and a second opposing end of the at least one hand truck attachment is configured for securely engaging the toe plate of a hand truck. At least a portion of a weight of the ladder is transferred onto the toe plate of the hand truck when the ladder is transported on the hand truck with the ladder support contacting the ladder thereof.

According to one or more embodiments, the at least one hand truck attachment comprises two hand truck attachments that removably attach to the toe plate of the hand truck.

According to one or more embodiments, the at least one hand truck attachment comprises two clip members that removably slide into the toe plate of the hand truck.

According to one or more embodiments, at least one hand truck attachment comprises two rods pivotably attached to a main frame of the hand truck through a hitch pin arrangement.

According to one or more embodiments, the at least one hand truck attachment comprises two rods pivotably attached to the toe plate through a hitch pin arrangement.

According to one or more embodiments, the at least one hand truck attachment comprises a screw clamp for securing the at least one hand truck attachment to the toe plate by tightening of the screw clamp.

According to one or more embodiments, the at least one hand truck attachment comprises a spring clamp for securing the at least one hand truck attachment to the toe plate by spring action of a resilient member of the spring clamp.

According to one or more embodiments, the at least one hand truck attachment comprises: a screw clamp for securing the at least one hand truck attachment to the toe plate by tightening of the screw clamp; and, a spring clamp for securing the at least one hand truck attachment to the toe plate by spring action of a resilient member of the spring clamp.

According to one or more embodiments, the at least one hand truck attachment is removably coupled to the ladder support.

According to one or more embodiments, the at least one hand truck attachment is permanently coupled to the ladder support.

According to one or more embodiments, the at least one hand truck attachment and the ladder support are of single continuous construction to form a single unit.

According to one or more embodiments, the ladder support has a profile that does not extend beyond a free end of the toe plate.

According to one or more embodiments, the apparatus further comprises a crossbar cover for sliding over a topmost crossbar of the hand truck.

According to one or more embodiments, the at least one hand truck attachment is further configured for sliding over a side wall of wheelbarrow.

A method of transporting a ladder with a hand truck of the type having wheels and a laterally extending toe plate for supporting an item thereon is provided. According to various embodiments, the method includes providing an adapter apparatus. The adapter apparatus includes a ladder support configured for receiving a portion of a ladder thereof, and at least one hand truck attachment configured for engageably receiving the toe plate of the hand truck. A first end of the at least one hand truck attachment is coupled to the ladder support. A second opposing end of the at least one hand truck attachment is configured for securely engaging a toe plate of a hand truck. At least a portion of a weight of the ladder is transferred onto the toe plate of the hand truck when the ladder is transported on the hand truck with the ladder support contacting the ladder thereof. The method further includes positioning a portion of the ladder on the ladder support, and adjusting a disposition of the hand truck such that the ladder is off ground. The method furthermore includes moving the hand truck such that the ladder is transported from a first location to a second location.

According to one or more embodiments, the ladder support comprises a bar insertable through a hollow rung of the ladder, wherein the method further comprising inserting the bar through the hollow rung of the ladder.

According to one or more embodiments, the ladder support comprises a cradle configured for receiving a rung of the ladder therein, wherein the method further comprises receiving the rung of the ladder by the cradle.

According to one or more embodiments, the adaptor apparatus further comprises a pair of vertical members for receiving a side rail of the ladder therebetween, wherein the method further comprises placing a side rail of the ladder between the vertical members.

According to one or more embodiments, the method further comprises removably coupling the at least one hand truck attachment to the ladder support.

According to one or more embodiments, the method further comprises permanently coupling the at least one hand truck attachment to the ladder support.

### BRIEF DESCRIPTION OF THE DRAWINGS

The foregoing, as well as the following Detailed Description of preferred embodiments, is better understood when read in conjunction with the appended drawings. For the purposes of illustration, there is shown in the drawings exemplary embodiments; however, the presently disclosed subject matter is not limited to the specific methods and instrumentalities disclosed.

The embodiments illustrated, described, and discussed herein are illustrative of the present invention. As these embodiments of the present invention are described with reference to illustrations, various modifications or adaptations of the methods and or specific structures described may become apparent to those skilled in the art. It will be appreciated that modifications and variations are covered by the above teachings and within the scope of the appended claims without departing from the spirit and intended scope thereof. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

FIG. 1 is a front, top, side perspective view of an adapter apparatus, in accordance with at least one embodiment of the present invention.

FIG. 2 is a top view of an adapter apparatus.

FIG. 3 is a rear, top and side perspective view of an adapter apparatus.

FIG. 4 is a rear view of an adapter apparatus.

FIG. 5 is a side view of an adapter apparatus.

FIG. 6 is a rear, top and side perspective view of an adapter apparatus attached to a hand truck.

FIG. 7 is a rear, top and side perspective view of an adapter apparatus attached to a hand truck while supporting a ladder by a rung.

FIG. 8 is a rear, top and side perspective view of an adapter apparatus attached to a hand truck while supporting a step ladder by a side rail.

FIG. 9 is a side view of an adapter apparatus attached to a hand truck while supporting a step ladder by a side rail.

FIG. 10 is a rear, top, side perspective view of another embodiment of an adapter apparatus.

FIG. 11 is a front, bottom, side perspective view of an adapter apparatus.

FIG. 12 is a top view of an adapter apparatus.

FIG. 13 is a rear view of an adapter apparatus.

FIG. 14 is a side view of an adapter apparatus.

FIG. 15 is a bottom view of an adapter apparatus.

FIG. 16 is a rear, top, side perspective view of another embodiment of an adapter apparatus.

FIG. 17 is a rear, bottom, side perspective view of an adapter apparatus.

FIG. 18 is a top view of an adapter apparatus.

FIG. 19 is a rear view of an adapter apparatus.

FIG. 20 is a side view of an adapter apparatus.

FIG. 21 is a top view of a component of another embodiment of an adapter apparatus, where two of these components are assembled back to back to form the complete adapter apparatus.

FIG. 22 is a front, bottom, side perspective view of the component of an adapter apparatus.

FIG. 23 is a front view of the component.

FIG. 24 is a side view of the component.

FIG. 25 is a rear, top, side perspective view of the component.

FIG. 26 is a front, top, side perspective view of the component.

FIG. 27 is a top view of an adapter apparatus.

FIG. 28 is a front, top, side perspective views an adapter apparatus.

FIG. 29 is a front view of an adapter apparatus.

FIG. 30 is a side view of an adapter apparatus.

FIG. 31 is a front, bottom, side perspective view of an adapter apparatus.

FIG. 32 is a rear, bottom, side perspective view of an adapter apparatus.

FIG. 33 is a front, top, side perspective view of another embodiment of an adapter apparatus.

FIG. 34 is a front view of an adapter apparatus.

FIG. 35 is a front, bottom, side perspective view of an adapter apparatus.

FIG. 36 is a side view of an adapter apparatus.

FIG. 37 is a rear, top, side perspective view of another embodiment of an adapter apparatus.

FIG. 38 is a front, bottom, side perspective view of an adapter apparatus.

FIG. 39 is a rear, top, side perspective view of an adapter apparatus attached to a hand truck and extended.

FIG. 40 is a front, bottom, side perspective view of an adapter apparatus attached to a hand truck and extended.

FIG. 41 is a front, top, side perspective view of an adapter apparatus attached to a hand truck and retracted.

FIG. 42 is a rear, top, side perspective view of an adapter apparatus attached to a hand truck and retracted.

FIG. 43 is a rear, top, side perspective view of another embodiment of an adapter apparatus.

FIG. 44 is a rear, bottom, side perspective view of an adapter apparatus.

FIG. 45 is a rear view of an adapter apparatus.

FIG. 46 is a side view of an adapter apparatus.

FIG. 47 is a front, bottom, side perspective view of another embodiment of an adapter apparatus.

FIG. 48 is a front, bottom, side perspective view of one end of an adapter apparatus.

FIG. 49 is a side view of an adapter apparatus.

FIG. 50 is a front, bottom, side perspective view of another embodiment of an adapter apparatus.

FIG. 51 is a side view of an adapter apparatus.

FIG. 52 is a rear, top, side perspective view of an adapter apparatus attached to a hand truck.

FIG. 53 is a front, bottom, side perspective view of another embodiment of an adapter apparatus.

FIG. 54 is a side view of an adapter apparatus.

FIG. 55 is a rear, top, side perspective view of an adapter apparatus attached to a hand truck.

FIG. 56 is a front, top, side perspective view of another embodiment of an adapter apparatus.

FIG. 57 is a side view of an adapter apparatus.

FIG. 58 is a front view of an adapter apparatus.

FIG. 59 is a sectional view of an adapter apparatus.

FIG. 60 is a rear, top, side perspective view of an adapter apparatus attached to a hand truck.

FIG. 61 is a front, top, side perspective view of another embodiment of an adapter apparatus.

FIG. 62 is a side view of an adapter apparatus.

FIG. 63 is a front, top, side perspective view of another embodiment of an adapter apparatus.

FIG. 64 is a side view of an adapter apparatus.

FIG. 65 is a front, top, side perspective view of another embodiment of an adapter apparatus.

FIG. 66 is a side view of an adapter apparatus.

FIG. 67 is a front, top, side perspective view of another embodiment of an adapter apparatus.

FIG. 68 is a side view of an adapter apparatus.

FIG. 69 is a rear, top, side perspective view of an adapter apparatus attached to a hand truck.

FIG. 70 is a rear, top, side perspective view of another embodiment of an adapter apparatus.

FIG. 71 is a front, top, side perspective view of an adapter apparatus.

FIG. 72 is a front, top, side perspective view of another embodiment of an adapter apparatus.

FIG. 73 is a side view of an adapter apparatus.

FIG. 74 is a front, top, side perspective view of an adapter apparatus attached to a hand truck.

FIG. 75 is a front, top, side perspective view of another embodiment of an adapter apparatus.

FIG. 76 is a side view of an adapter apparatus.

FIG. 77 is a front, top, side perspective view of an adapter apparatus attached to a hand truck.

FIG. 78 is a front, top, side perspective view of another embodiment of an adapter apparatus.

FIG. 79 is a side view of an adapter apparatus.

FIG. 80 is a front, top, side perspective view of an adapter apparatus attached to a hand truck.

FIG. 81 is a front, top, side perspective view of another embodiment of an adapter apparatus.

FIG. 82 is a side view of an adapter apparatus.

FIG. 83 is a front, top, side perspective view of an adapter apparatus attached to a hand truck.

FIG. 84 is a front, top, side perspective view of another embodiment of an adapter apparatus.

FIG. 85 is a side view of an adapter apparatus.

FIG. 86 is a front, top, side perspective view of an adapter apparatus attached to a hand truck.

FIG. 87 is a front, top, side perspective view of another embodiment of an adapter apparatus.

FIG. 88 is a side view of an adapter apparatus.

FIG. 89 is a front, top, side perspective view of an adapter apparatus attached to a hand truck.

FIG. 90 is a front, top, side perspective view of another embodiment of an adapter apparatus.

FIG. 91 is a side view of an adapter apparatus.

FIG. 92 is a front, bottom, side perspective view of an adapter apparatus.

FIG. 93 is a rear, top, side perspective view of another embodiment of an adapter apparatus.

FIG. 94 is a side view of an adapter apparatus.

FIG. 95 is a rear, top, side perspective view of an adapter apparatus attached to a hand truck.

FIG. 96 is a rear, top, side perspective view of an adapter apparatus attached to a hand truck while supporting a ladder.

FIG. 97 is a front, bottom, side perspective view of another embodiment of an adapter apparatus.

FIG. 98 is a side view of an adapter apparatus.

FIG. 99 is a front, top, side perspective view of an adapter apparatus attached to a hand truck.

FIG. 100 is a front, bottom, side perspective view of another embodiment of an adapter apparatus.

FIG. 101 is a side view of an adapter apparatus.

FIG. 102 is a front, top, side perspective view of an adapter apparatus attached to a hand truck.

FIG. 103 is a rear, top, side perspective view of another embodiment of an adapter apparatus.

FIG. 104 is a top view of an adapter apparatus.

FIG. 105 is a rear view of an adapter apparatus.

FIG. 106 is a side view of an adapter apparatus.

FIG. 107 is a front, top, side perspective view of another embodiment of an adapter apparatus, retracted.

FIG. 108 is a side view of an adapter apparatus, retracted.

FIG. 109 is a front view of an adapter apparatus, retracted.

FIG. 110 is a front, top, side perspective view of an adapter apparatus, extended.

FIG. 111 is a side view of an adapter apparatus, extended.

FIG. 112 is a front view of an adapter apparatus, extended.

FIG. 113 is a perspective view of a modified hand truck toe plate.

FIG. 114 is a perspective view of a hand truck with an adapter apparatus retracted.

FIG. 115 is a detail view of a retracted adapter apparatus attached to a hand truck.

FIG. 116 is a perspective view of a hand truck with an adapter apparatus extended.

FIG. 117 is a detail view of an extended adapter apparatus attached to the hand truck.

FIG. 118 is a rear, top, side perspective view of base components of another embodiment of an adapter apparatus.

FIG. 119 is a side view of the base components of an adapter apparatus.

FIG. 120 is a front, top, side perspective view of the base components of an adapter apparatus.

FIG. 121 is an opposite side view of the base components of an adapter apparatus.

FIG. 122 is a front, top, side perspective view of the ladder support components of an adapter apparatus.

FIG. 123 is a side view of ladder support components of an adapter apparatus.

FIG. 124 is a rear, bottom, side perspective view of ladder support components of an adapter apparatus.

FIG. 125 is a rear, top, side perspective view of a complete adapter apparatus.

FIG. 126 is a side view of a complete adapter apparatus.

FIG. 127 is a rear, bottom, side perspective view of a complete adapter apparatus.

FIG. 128 is a rear, top, side perspective view of the base components of another embodiment of an adapter apparatus.

FIG. 129 is a side view of base components of an adapter apparatus.

FIG. 130 is a front, top, side perspective view of base components of an adapter apparatus.

FIG. 131 is an opposite side view of base components of an adapter apparatus.

FIG. 132 is a front, top, side perspective view of ladder support components of an adapter apparatus.

FIG. 133 is a side view of ladder support components of an adapter apparatus.

FIG. 134 is a front, bottom, side perspective view of ladder support components of an adapter apparatus.

FIG. 135 is a rear, top, side perspective view of a complete adapter apparatus.

FIG. 136 is a side view of the complete adapter apparatus.

FIG. 137 is a rear, bottom, side perspective view of the complete adapter apparatus.

FIG. 138 is a front, bottom, side perspective view of another embodiment of an adapter apparatus.

FIG. 139 is a side view of an adapter apparatus.

FIG. 140 is a front, bottom, side perspective view of another embodiment of an adapter apparatus, specifically the hand truck attachment.

FIG. 141 is a side view of an adapter apparatus.

FIG. 142 is a front, bottom, side perspective view of another embodiment of an adapter apparatus, specifically the hand truck attachment.

FIG. 143 is a side view of an adapter apparatus.

FIG. 144 is a front, bottom, side perspective view of another embodiment of an adapter apparatus, specifically the hand truck attachment.

FIG. 145 is a side view of an adapter apparatus.

FIG. 146 is a front, bottom, side perspective view of another embodiment of an adapter apparatus.

FIG. 147 is a detail view of FIG. 146.

FIG. 148 is a side view of an adapter apparatus attached to a hand truck.

FIG. 149 is cross section view of FIG. 148.

FIG. 150 is a detail view of FIG. 149, showing the hand truck attachment clamped to the hand truck toe plate.

FIG. 151 is a detail view of FIG. 149, showing the hand truck attachment unclamped and ready to remove from the hand truck toe plate.

FIG. 152 is a front, top, side perspective view of a crossbar end support, which is a secondary ladder support component of an adapter apparatus.

FIG. 153 is front view of an adapter apparatus.

FIG. 154 is a side view of an adapter apparatus.

FIG. 155 is a front, top, side perspective view of an adapter apparatus attached to a hand truck.

FIG. 156 is a front, top, side perspective view of an adapter apparatus attached to a hand truck, supporting a ladder.

FIG. 157 is a front, top, side perspective view of a crossbar cover, which is a secondary ladder support component of an adapter apparatus.

FIG. 158 is a side view of an adapter apparatus.

FIG. 159 is a perspective view of a hand truck.

FIG. 160 is a perspective view of a hand truck with the crossbar cover attached.

FIG. 161 is perspective view of a convertible hand truck set up as a hand truck.

FIG. 162 is perspective view of a convertible hand truck set up as a hand cart.

FIG. 163 is a front, top, side perspective view of another embodiment of an adapter apparatus.

FIG. 164 is a side view of an adapter apparatus.

FIG. 165 is a front, top, side perspective view of an adapter apparatus attached to a hand truck.

FIG. 166 is detail view of an adapter apparatus from FIG. 165.

FIG. 167 is a front, top, side perspective view of an adapter apparatus attached to a hand truck without the hand truck toe plate or ladder support inserted.

FIG. 168 is a rear, top, side perspective view of an adapter apparatus attached to a hand truck without the hand truck toe plate or ladder support inserted.

FIG. 169 is a front, top, side perspective view of an adapter apparatus attached to a hand truck with the hand truck toe plate inserted.

FIG. 170 is a front, top, side perspective view of an adapter apparatus attached to a hand truck with the ladder support inserted.

FIG. 171 is a perspective view of a man pulling a ladder that is strapped to an adapter apparatus that is attached to a hand truck.

FIG. 172 is a perspective view of an adapter apparatus attached to a wheelbarrow type hand truck.

FIG. 173 is a side view of an adapter apparatus attached to a wheelbarrow type hand truck.

### DETAILED DESCRIPTION OF THE EMBODIMENTS

Below, the technical solutions in the examples of the present invention are depicted clearly and comprehensively with reference to the figures according to the examples of the present invention. Obviously, the examples depicted here are merely some examples, but not all examples of the present invention. In general, the components in the examples of the present invention depicted and shown in the figures herein can be arranged and designed according to different configurations. Thus, detailed description of the examples of the present invention provided in the figures below are not intended to limit the scope of the present invention as claimed, but merely represent selected examples of the present invention. On the basis of the examples of the present invention, all of other examples that could be obtained by a person skilled in the art without using inventive efforts will fall within the scope of protection of the present invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of an adapter assembly or apparatus and the practical application, and to enable others of ordinary skill in the art to understand an adapter assembly or apparatus for various embodiments with various modifications as are suited to the particular use contemplated.

These and other changes can be made to the disclosure in light of the Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description of The Embodiments section explicitly defines such terms. Accordingly, the actual scope of the disclosure encompasses not only the disclosed embodiments, but also all equivalent ways of practicing or implementing the disclosure under the claims.

Unless defined otherwise, all technical and scientific terms used herein have the same meaning as commonly understood to one of ordinary skill in the art to which the presently disclosed subject matter pertains. Although any methods, devices, and materials similar or equivalent to those described herein can be used in the practice or testing of the presently disclosed subject matter, representative methods, devices, and materials are now described.

Following long-standing patent law convention, the terms “a”, “an”, and “the” refer to “one or more” when used in the subject specification, including the claims. Thus, for example, reference to “a device” can include a plurality of such devices, and so forth.

Unless otherwise indicated, all numbers expressing quantities of components, conditions, and so forth used in the specification and claims are to be understood as being modified in all instances by the term “about”. Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, concentration, and/or percentage can encompass variations of, in some embodiments+/−20%, in some embodiments+/−10%, in some embodiments+/−5%, in some embodiments+/−1%, in some embodiments+/−0.5%, and in some embodiments+/−0.1%, from the specified amount, as such variations are appropriate in the disclosed packages and methods.

As noted earlier, firefighters are limited in the amount of equipment they can carry on the truck as well as the amount they carry from the truck to the fire. Fire trucks are often parked a great distance from the fire due to safety reasons or because of crowded city streets, forcing the fire fighters to walk a long distance carrying their ladder and other equipment. Currently when fire fighters arrive at the scene, they first load a ladder on a ladder dolly, then stack other equipment on top of the ladder before heading to the final location. Various embodiments of the presently disclosed subject matter can advantageously solve problems faced by firefighters in transporting ladders in an efficient manner by allowing a fire fighter to use the hand truck as both a hand truck and a ladder dolly giving the fire fighter two tools that effectively occupy the same space as a single hand truck. In addition to saving space, Various embodiments of the presently disclosed subject matter further provide for an economical solution as compared a single purpose ladder dolly. A single purpose ladder dolly can cost more than 4 times the price of this adapter apparatus and a hand truck combined. This elegant, cost efficient design makes this adapter apparatus feasible for the average homeowner to purchase.

Various embodiments of the presently disclosed subject matter are directed to a ladder dolly adapter assembly (“the adapter assembly”). The adapter assembly as described herein can enable a hand truck to be used as a ladder dolly; the adapter assembly may be removably installed by an end user or it may be constructed as an integrated part of the hand truck by the hand truck manufacturer. The adapter assembly can comprise at least a “ladder support” and a “hand truck attachment”.

As mentioned herein, the term “ladder support” represents a component or group of components of the adapter assembly that can support and or hold on to a ladder. A “ladder support” may or may not have an integrated means of securing the ladder to the “ladder support”. The “ladder support” may be fixed or movable to support the ladder in any 3D direction, to assist with both moving the ladder and helping perform a rescue. The ladder support may also include components such as integrated clamps or straps for securing the ladder to the device, padding to protect the ladder from damage, anti-theft cable, anti-theft alarm and or ornamental components. One embodiment of the ladder support can support and hold the ladder by cradling one rung/step. Another embodiment of a ladder support can support the ladder by inserting a structural member inside the hollow rung of a ladder. A further embodiment of the ladder support can support the ladder by supporting one or more side rails. One embodiment of ladder support can have multiple surfaces, allowing it to support the ladder by either cradling the rung/step or by supporting one or more side rails. Another embodiment of ladder support can have multiple surfaces in two different locations, allowing it to support the first location on the ladder by either cradling the rung/step or by supporting one or more side rails and a second location providing additional support by either cradling the rung/step or by supporting one or more side rails. Another embodiment of ladder support includes a vertical component which supports a ladder when tipped up on one side rail.

As mentioned herein, the term “hand truck attachment” represents a component or group of components that enables attaching the adapter assembly to the hand truck. One embodiment of the hand truck attachment can temporarily grip the hand truck toe plate; this design can enable the end user to attach and detach the adapter assembly. Another embodiment of the hand truck attachment can temporarily grip the hand truck frame; this design can enable the end user to attach and detach the adapter assembly. Another embodiment of the hand truck attachment can represent an integrated part of the hand truck. Another embodiment of the hand truck attachment can represent an integrated part of the hand truck which may still be removable by the end user.

As mentioned herein, the term “hand truck” includes a hand-propelled or motor propelled barrow consisting of a frame having one or more handles at or near one end of the frame; one or more wheels and one or more load carrying surfaces such as forks, toe plate, platform or bin, attached to the frame. A hand truck may use the frame as a handle, in place of a dedicated handle. A hand truck may use the frame as a load carrying surface, in place of or in addition to a dedicated load carrying surface. A hand truck may be built with immovable parts or movable parts or any combination of these parts to assist with storage and or to change the load carrying mode. A hand truck may exhibit physical characteristics in addition to the frame, the handling area, the load carrying surfaces, and the one or more wheels. A hand truck may use tracks, belts, skis, or glides in place of, or in addition to one or more wheels for climbing difficult surfaces, such as stairs, loading docks, logs, sand, mud, snow, and ice, etcetera. Examples of names commonly used to reference hand trucks are hand truck, convertible hand truck, folding hand truck, motorized hand truck, stair climbing hand truck, motorized stair climbing hand truck, appliance hand truck, cylinder hand truck, bag truck, sack truck, sack dolly, game truck, dolly, hand cart, wheelbarrow, or hand trolley.

As mentioned herein, the term “ladder step” or “step” can be a flat cross member between the side rails of a step ladder, used as a step for climbing the ladder. A ladder step may also take the form of other shapes, and it is the primary means of ascending and descending the step ladder. This definition of “ladder step” is not meant to limit the claims of this patent, but instead it's here to help the reader understand that this adapter apparatus will enable a hand truck to carry any type of portable ladder regardless of the stair tread, step, or rung type.

As mentioned herein, the term “ladder rung” or “rung” can be a hollow cross member between the side rails of a single ladder or extension ladder, used as a step for climbing the ladder. Rungs tend to be shorter in depth, more cylindrical or D shaped which makes the ladder safer because one can get a better hand grip on a rung than one can a step, reducing the need for a handrail. A ladder rung may also take the form of other shapes, and it is the primary means of ascending and descending the straight ladder or extension ladder. This definition of “ladder rung” is not meant to limit the claims of this patent, but instead it's here to help the reader understand that this adapter apparatus will enable a hand truck to carry any type of portable ladder regardless of the stair tread, step, or rung type.

Referring now to the drawings, which are meant to be exemplary and not limiting, and wherein like elements are numbered alike. The detailed description is set forth with reference to the accompanying drawings illustrating examples of the disclosure, in which use of the same reference numerals indicates similar or identical items. Certain embodiments of the present disclosure may include elements, components, and/or configurations other than those illustrated in the drawings, and some of the elements, components, and/or configurations illustrated in the drawings may not be present in certain embodiments.

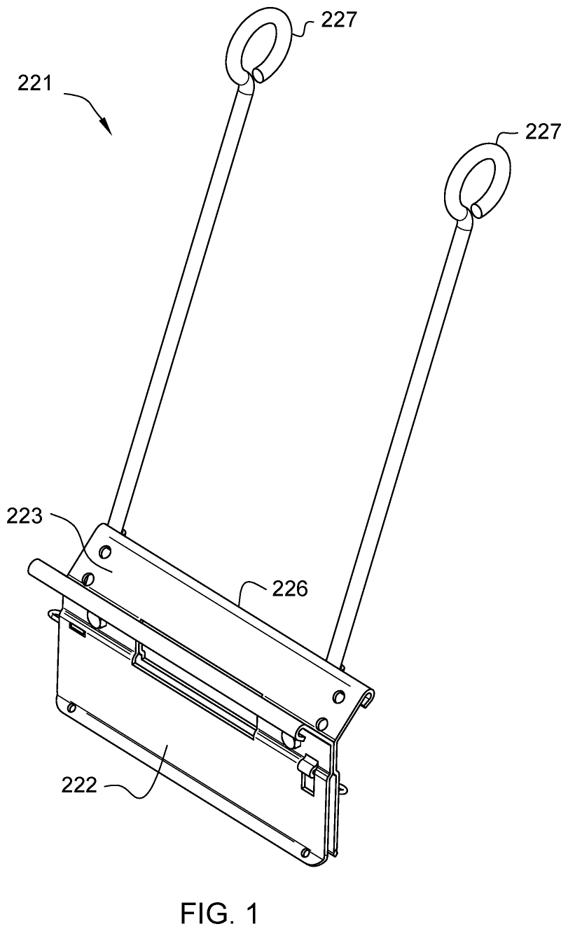

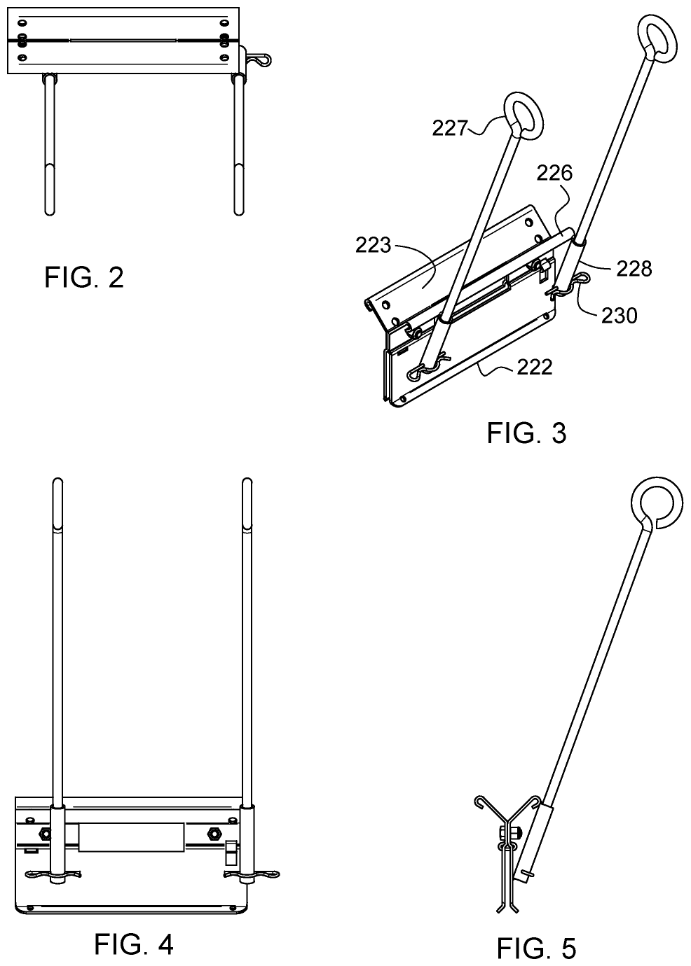

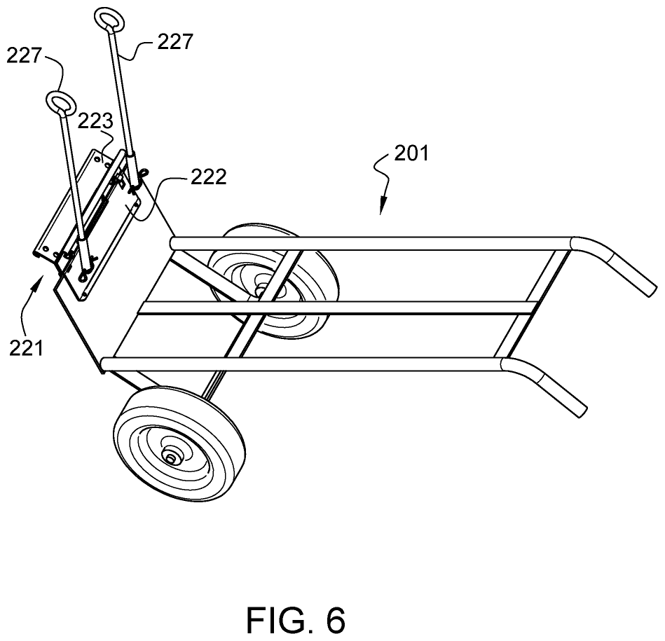

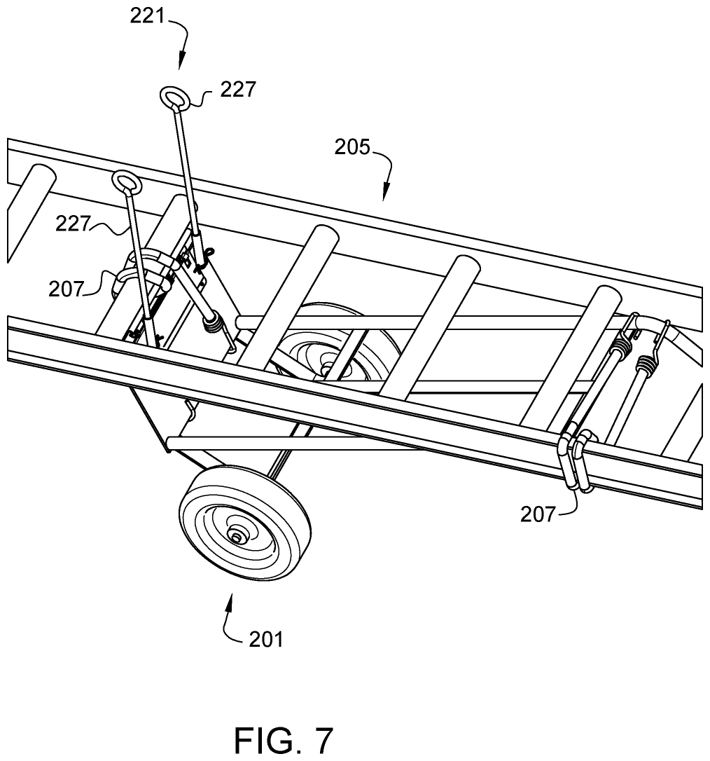

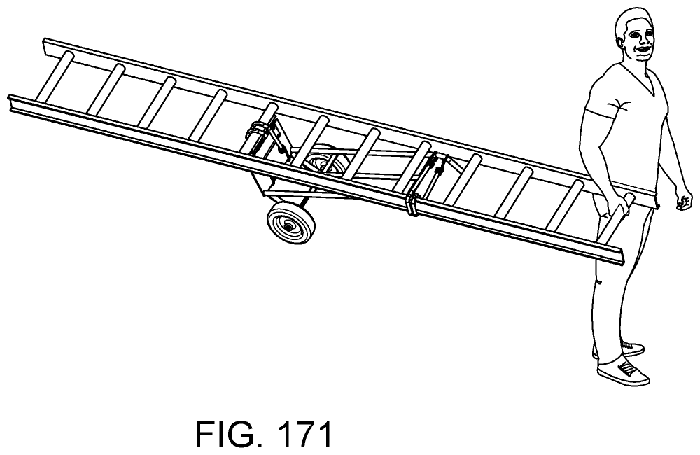

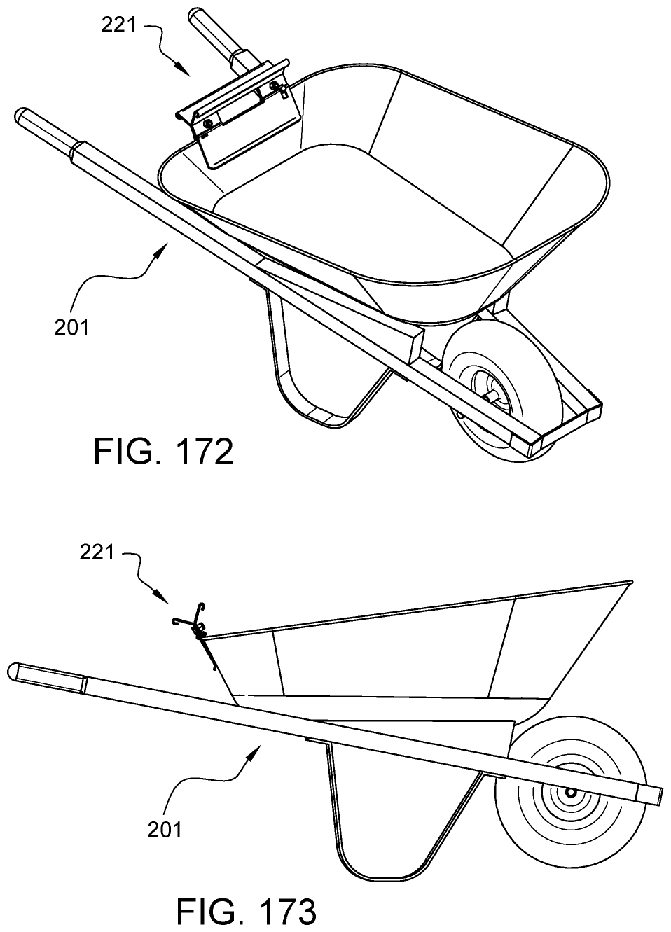

Referring to FIGS. 1 through 6, according to various embodiments, an adapter assembly 221 (alternately referred to herein as “assembly 221” or simply “assembly”) is configured for transporting a ladder such as ladder 205 with a hand truck 201. According to various embodiments, the adapter assembly as described herein is configured for transporting a ladder with a hand truck of the type having wheels and a laterally extending toe plate for supporting an item thereon. In at least one embodiment, the hand truck can have a configuration, as illustrated, for example, in FIG. 6 (see item marked 201 in FIG. 6). In various embodiments, adapter assembly 221 comprises a ladder support 223 configured for receiving a portion of a ladder thereof and a hand truck attachment 222 configured for engageably receiving toe plate 202 of the hand truck. A first end of hand truck attachment 222 is coupled to ladder support 223 while a second opposing end of one hand truck attachment 222 is configured for securely engaging a toe plate 202 of hand truck 201. As illustrated, for example, in FIG. 171, at least a portion of a weight of the ladder is transferred onto toe plate 202 of hand truck 201 when ladder 205 is transported on hand truck 201 with ladder support 223 contacting ladder 205 thereof. In some embodiments, as illustrated, for example, in FIG. 7, a bungee cord such as bungee strap 207 may be used to further secure the ladder to the hand truck to minimize or eliminate inadvertent motion of the ladder relative to the hand truck.

Ladder support 223 and hand truck attachment 222 as illustrated in FIGS. 1-6 represent just one configuration of the ladder support and the hand truck attachment. Accordingly, the ladder support and the hand truck attachment can take various other forms as shown in throughout FIGS. 1 through 173 and/or as explained below. For example, in one embodiment, the ladder support can take the form of a bar 231 (see FIG. 103, for example) that is insertable through a hollow rung of a ladder. In one embodiment, the ladder support comprises a cradle (for e.g., see FIGS. 1, 16, 30, 33, 43, 56 etc.) configured for receiving a rung of the ladder therein. Accordingly, ladder support 223 for cradling a ladder rung or step, ladder support 226 for horizontally supporting a ladder side rail, vertical ladder support 227 for vertically supporting a ladder side rail, and hand truck attachment 222 as illustrated in FIGS. 1-6

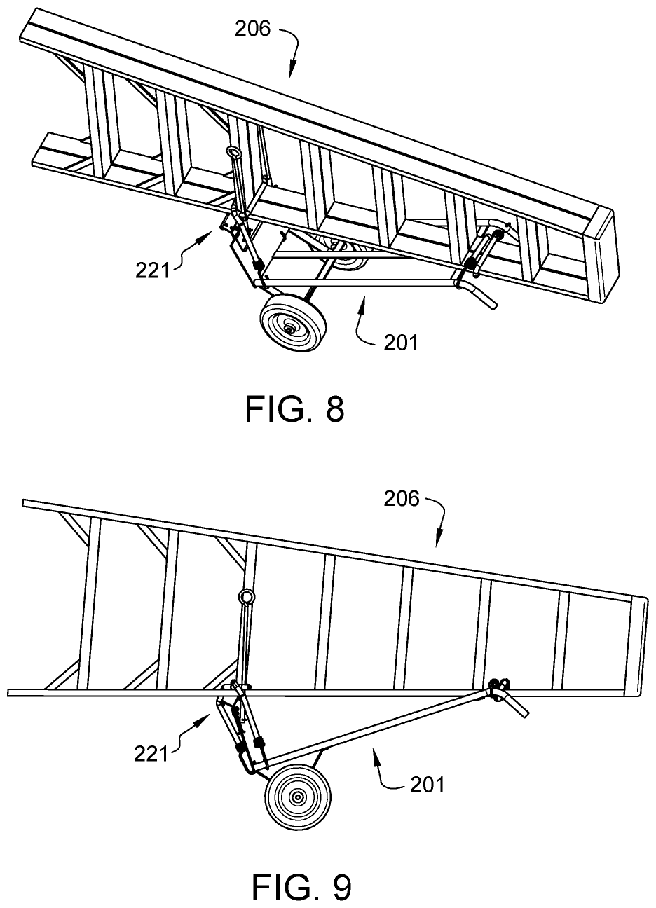

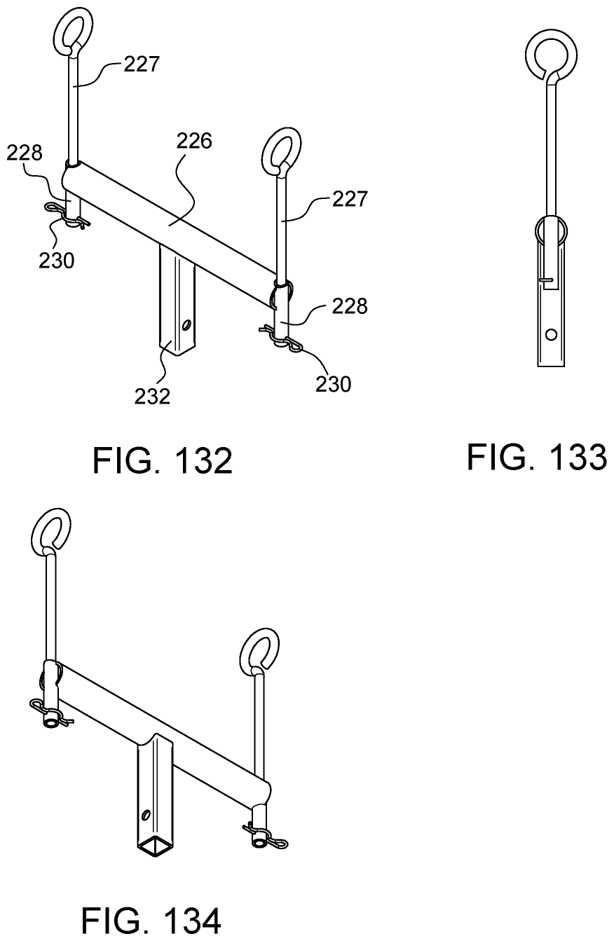

In at least one embodiment, as illustrated in FIGS. 3 and 8, for example, the assembly can further include a pair of vertical members 227 for receiving a side rail of a step ladder 206 therebetween; further, in at least one embodiment, as illustrated, for example, in FIG. 132, the assembly can include vertical member sockets 228 for receiving vertical members 227. In at least one embodiment, a clip such as hair pin clip 230 operates to secure vertical members 227 within vertical member sockets 228 as illustrated in FIG. 3, for example.

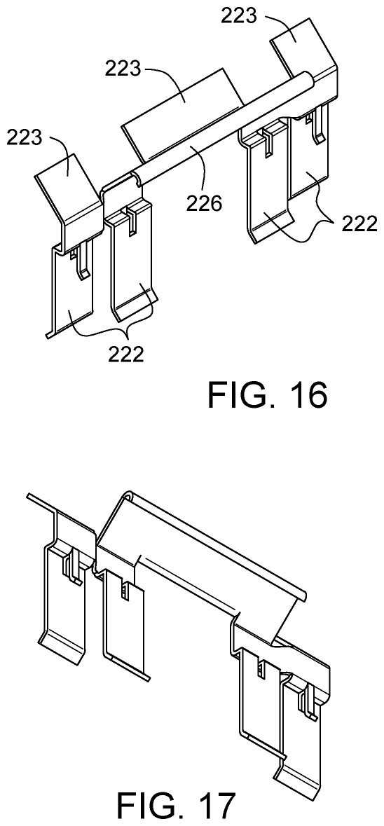

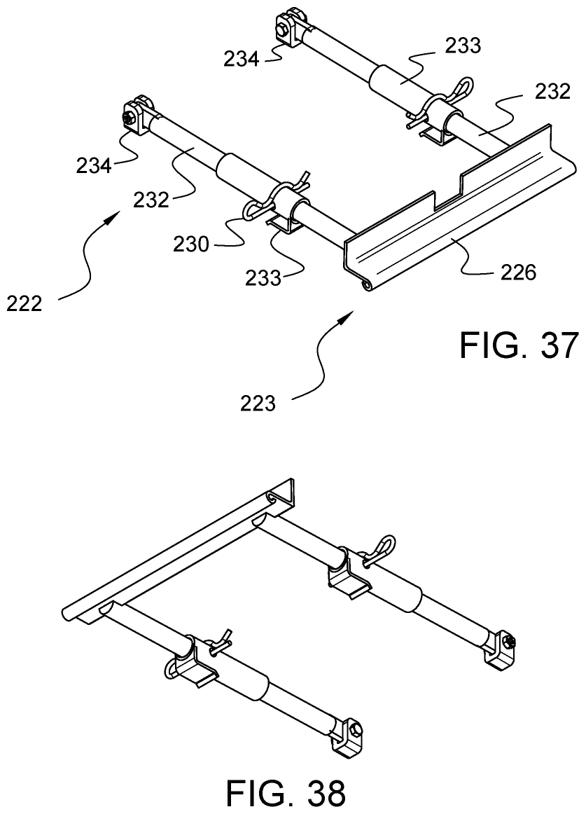

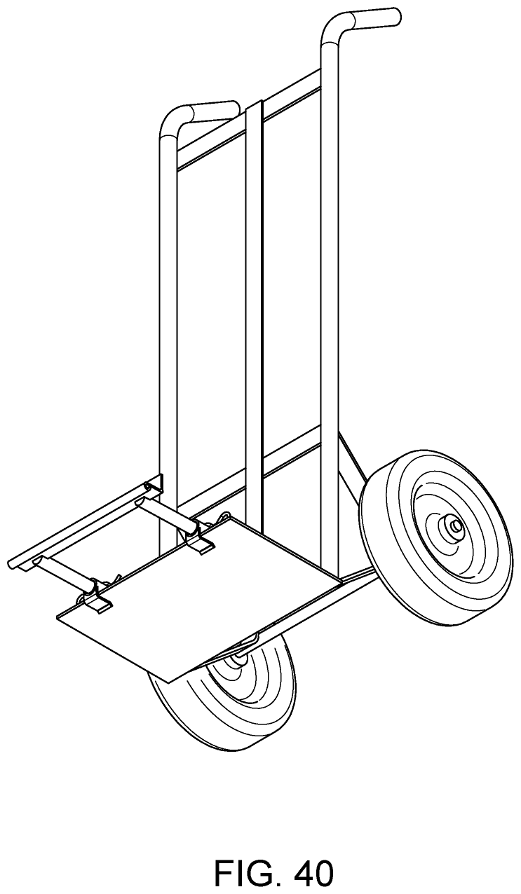

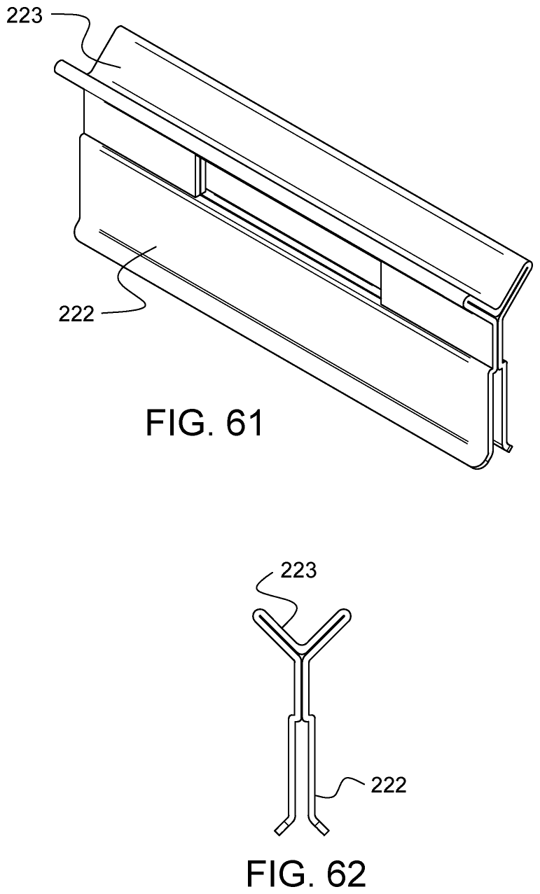

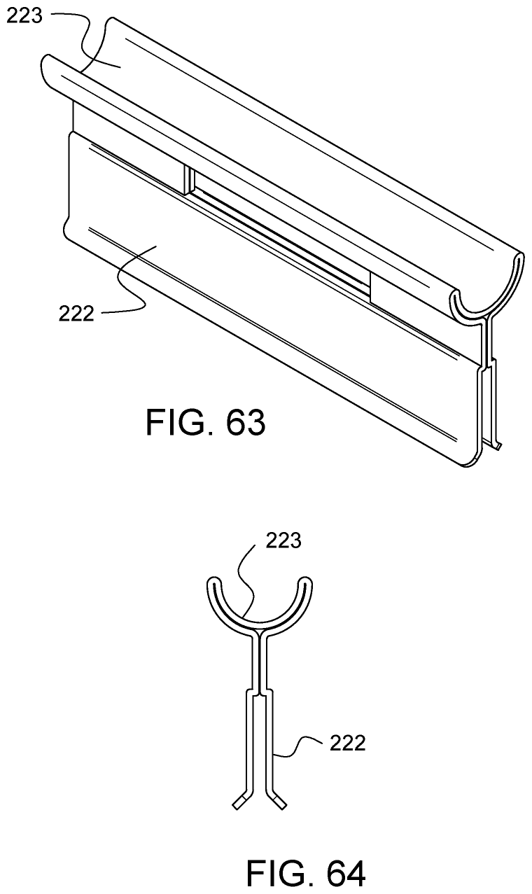

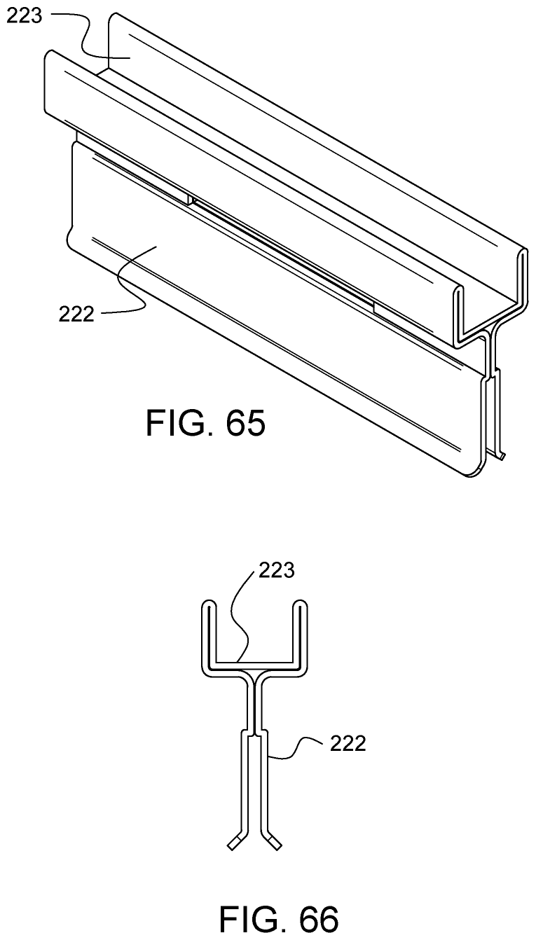

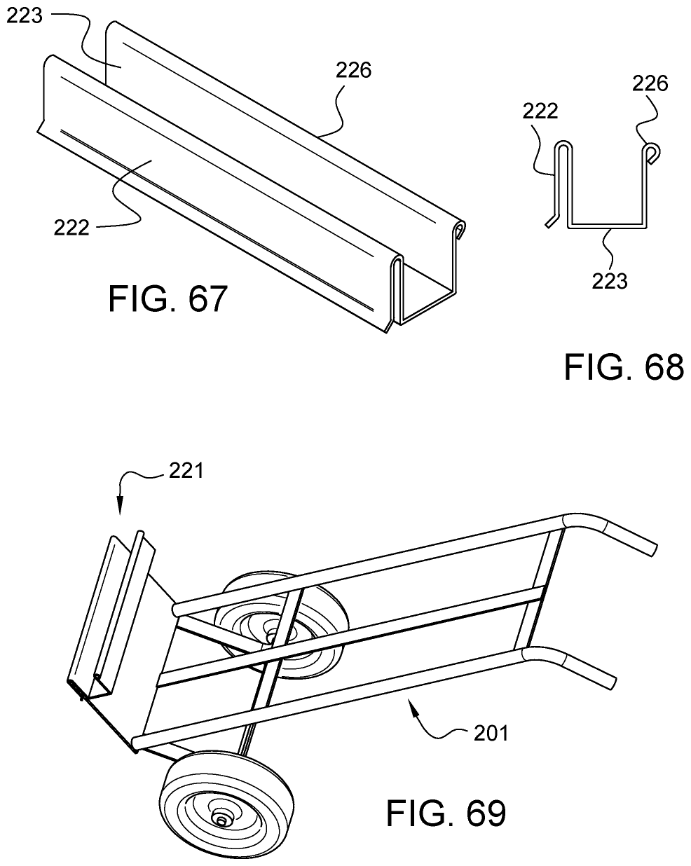

In at least one embodiment, as illustrated in FIGS. 16 and 17, for example, the hand truck attachment can include two or more clip members that removably slide onto the toe plate of the hand truck. In at least one embodiment, as illustrated in FIGS. 37 through 40, for example, hand truck attachment can include two support arms 232 pivotably attached to the toe plate through support arm pivot 234 (see FIG. 37 and FIG. 39). Alternately, the two rods may also be pivotably attached to a main frame of the hand truck through support arm pivot 234. A further alternate method of attachment could be; omit support arm pivot 234 and modify support arm 232 by omitting the two flats, drill a ¼″ hole through the hand truck frame aligned with existing ¼″ hole in support arm 232, insert a ¼″-20 bolt through the drilled hole in the hand truck frame and support arm 232, apply a lock nut tight enough to allow the assembly to pivot on the said bolt. In at least one embodiment, the hand truck attachment can take the form of a set of first support arms 232 that connect a set of second support arms 232 to the main frame of the hand truck. In at least one embodiment, a support arm latch 233 and a hair pin clip 230 operate to latch the apparatus in the up or down position (see FIGS. 39-42). In some embodiments, the ladder support can take the form of a horizontal ladder side support such as support 226 as illustrated, for example, in FIG. 67. In at least one embodiment, as illustrated, for example, in FIG. 132, the apparatus includes vertical member sockets 228 for receiving vertical members 227.

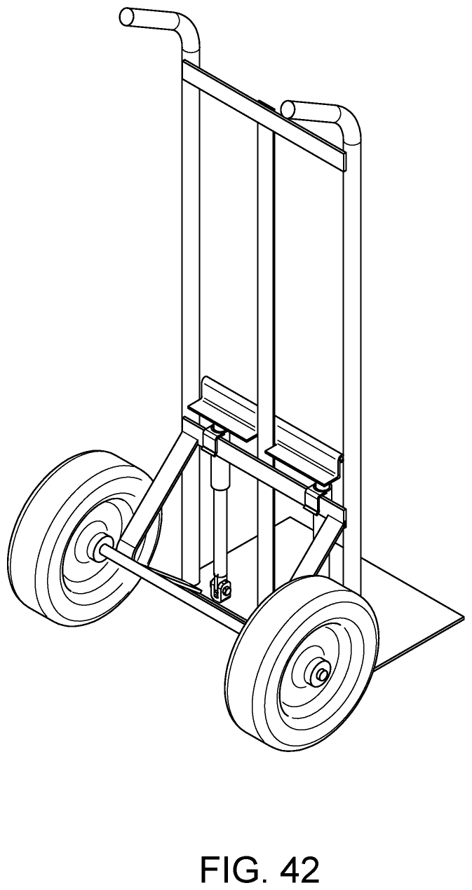

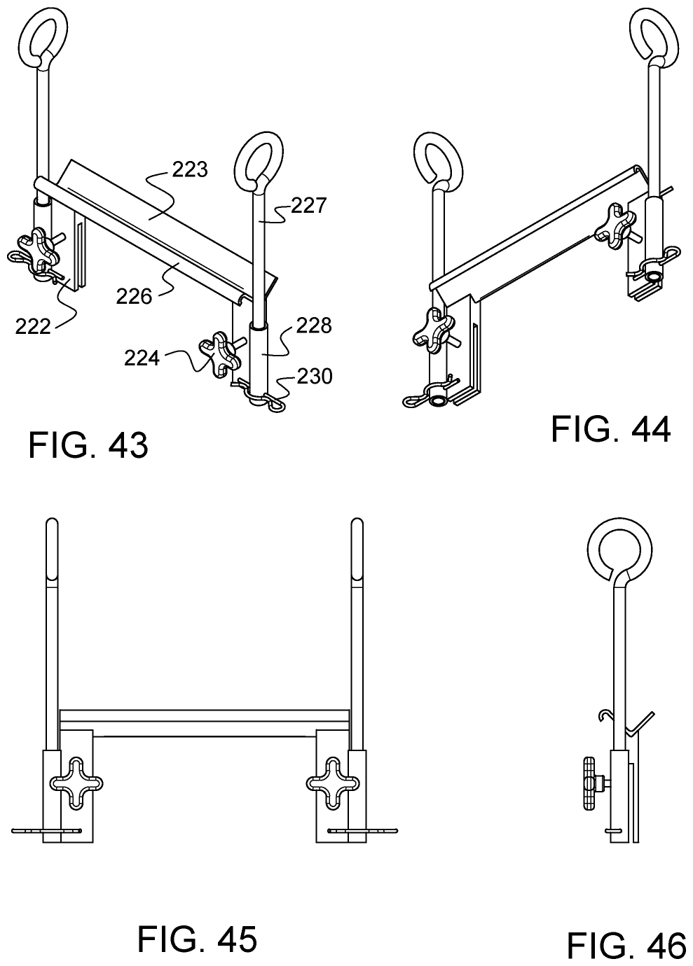

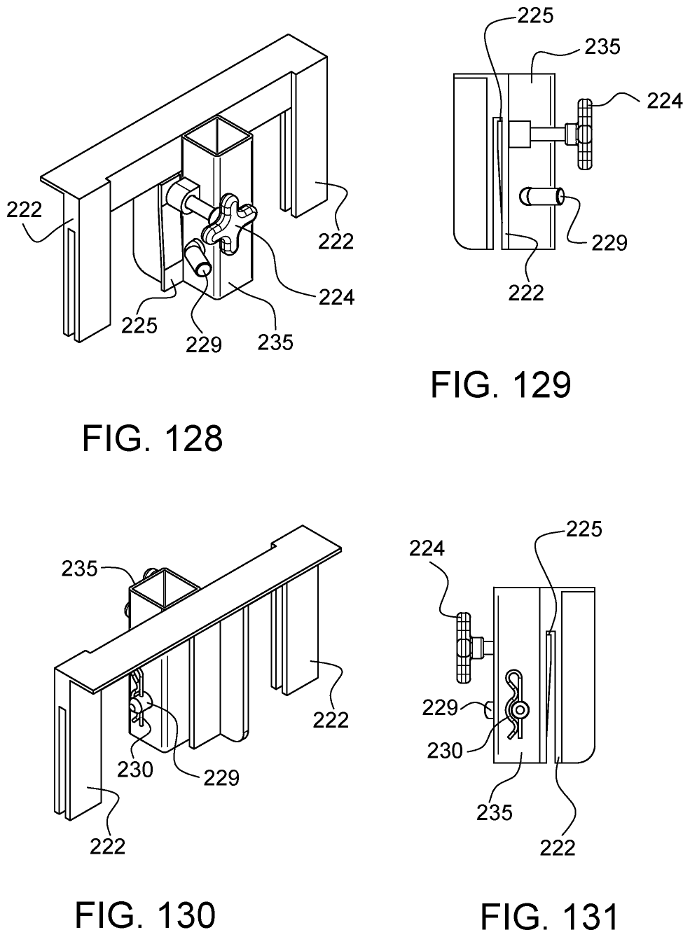

In at least one embodiment, as illustrated in FIGS. 16 and 17, for example, the hand truck attachment can be in the form of two hand truck attachments that removably attach to the toe plate of the hand truck. In at least one embodiment, as illustrated in FIGS. 43 through 46, for example, hand truck attachment further includes a screw clamp 224 for securing the at least one hand truck attachment to the toe plate by tightening of screw clamp 224. In at least one embodiment, as illustrated in FIGS. 150-151, for example, the hand truck attachment further includes a spring clamp 225 for securing the at least one hand truck attachment to the toe plate by spring action of a resilient member of spring clamp 225. In at least one embodiment, as illustrated in FIG. 128, for example, the hand truck attachment includes screw clamp 224 and spring clamp 225. In some embodiments, the hand truck attachment may be removably coupled to the ladder support whereas in some alternate embodiments, the hand truck attachment is permanently coupled to the ladder support. In some embodiments, the hand truck attachment and the ladder support are of single continuous construction to form a single unit; in other words, in such embodiments, the hand truck attachment and the ladder support are in the form of a singular unit that may be, for example, by molding. In some embodiments, the hand truck attachment is further configured for sliding over a side wall of wheelbarrow as illustrated, for example, in FIGS. 172 and 173.

In at least one embodiment, the assembly can further include a crossbar cover 208 as illustrates, for example, in FIGS. 158 through 160. FIG. 158 illustrates the crossbar cover 208 in a side view. FIG. 159 illustrates a typical hand truck without the crossbar cover 208 attached. FIG. 160 illustrates the same hand truck with the crossbar cover 208 attached. Crossbar cover 208 can be configured for sliding over a topmost crossbar of the hand truck. Crossbar cover 208 can advantageously help in transporting a ladder placed thereon.

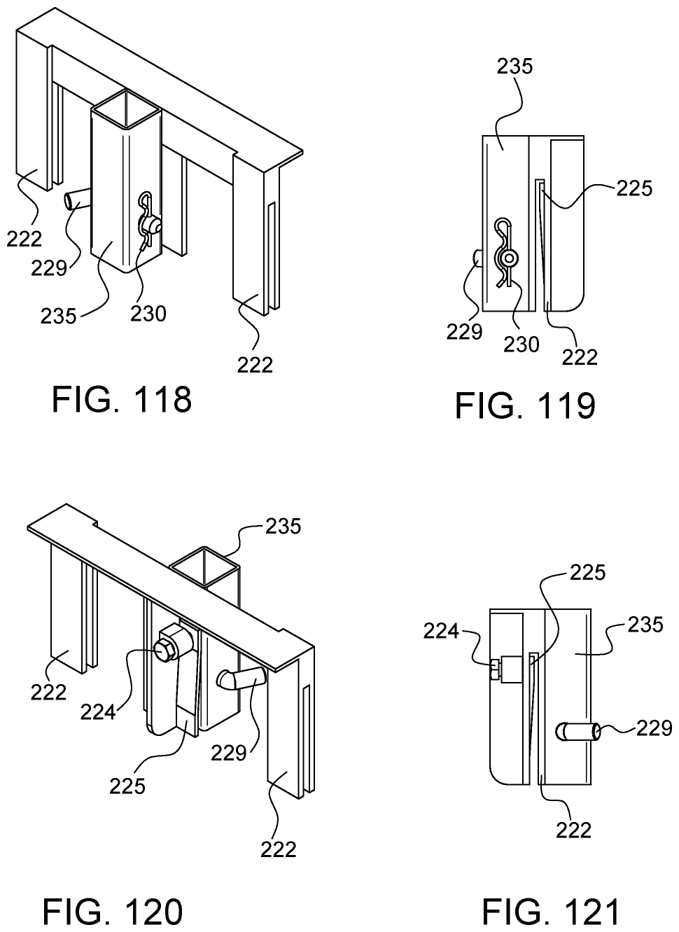

In some embodiments, the assembly can further include an implement receiver 235 to allow swapping of different ladder supports as illustrated, for example, in FIGS. 118-121. Implement receiver 235 can attach to toe plate 202 and can accept various ladder support heads. In at least one embodiment, implement receiver 235 can act as a socket to hold the ladder support.

In some embodiments, the assembly has a profile that does not extend beyond a free end of the toe plate as illustrated, for example, in FIGS. 69, 74, 77, 80, 83, 86, and 89.

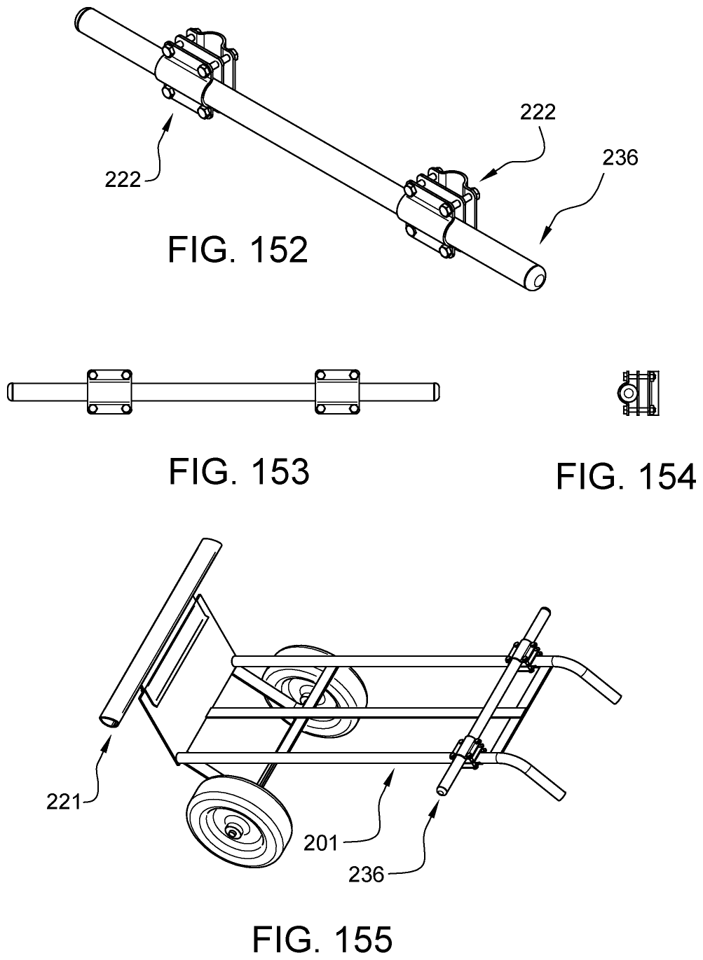

In at least one embodiment, as illustrated in FIGS. 152-156, for example, the adapter assembly includes a crossbar end support 236 which offers an additional ladder support position (in addition to a first ladder support position provided by way of ladder support 223) which is removably mounted near the handle end of the hand truck 201.

According to at least one embodiment, a method of transporting a ladder with a hand truck of the type having wheels and a laterally extending toe plate for supporting an item thereon is provided. The method includes providing an adapter assembly. The adapter assembly includes a ladder support configured for receiving a portion of a ladder thereof, and at least one hand truck attachment configured for engageably receiving the toe plate of the hand truck. A first end of the at least one hand truck attachment is coupled to the ladder support. A second opposing end of the at least one hand truck attachment is configured for securely engaging a toe plate of a hand truck. At least a portion of a weight of the ladder is transferred onto the toe plate of the hand truck when the ladder is transported on the hand truck with the ladder support contacting the ladder thereof. The method further includes positioning a portion of the ladder on the ladder support and adjusting a disposition of the hand truck such that the ladder is off ground. The method furthermore includes moving the hand truck such that the ladder is transported from a first location to a second location.

According to one or more embodiments, the ladder support comprises a bar insertable through a hollow rung of the ladder, wherein the method further comprising inserting the bar through the hollow rung of the ladder. According to one or more embodiments, the ladder support comprises a cradle configured for receiving a rung of the ladder therein, wherein the method further comprises receiving the rung of the ladder by the cradle. According to one or more embodiments, the adaptor assembly further comprises a pair of vertical members for receiving a side rail of the ladder therebetween, wherein the method further comprises placing a side rail of the ladder between the vertical members. According to one or more embodiments, the method further comprises removably coupling the at least one hand truck attachment to the ladder support. According to one or more embodiments, the method further comprises permanently coupling the at least one hand truck attachment to the ladder support.

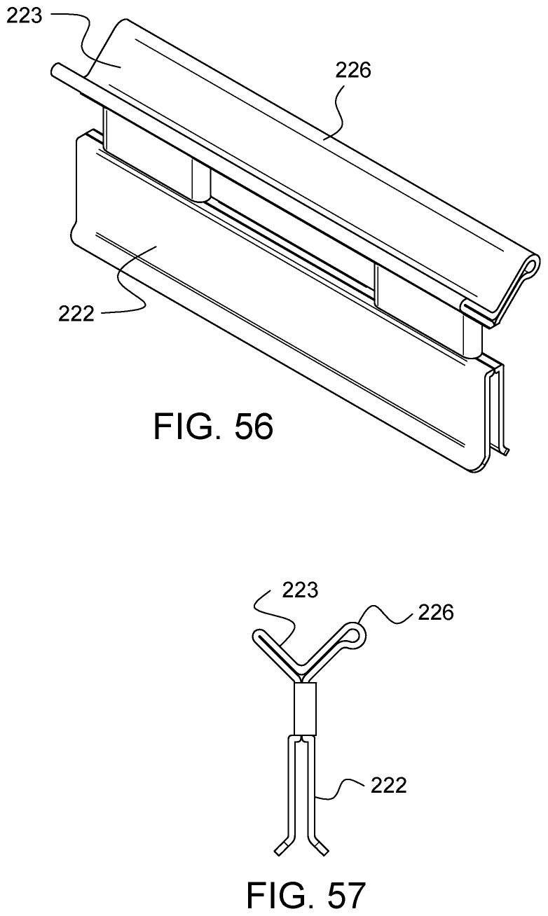

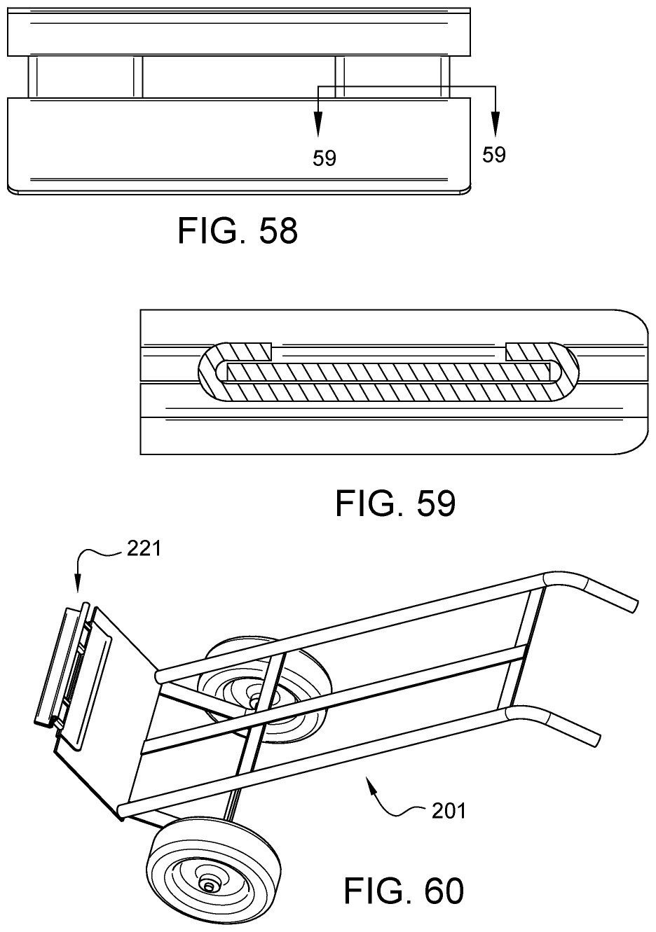

FIGS. 1-5 illustrate one embodiment of the adapter apparatus 221, FIGS. 6-9 illustrate the adapter apparatus attached to a hand truck 201, with and without a ladder attached. This embodiment is removably installed and is made from two identically formed sheets of steel, 11″ wide and 0.125″ thickness, fastened back to back by a pair of ⅜-16 nuts and bolts centered within the area on each side of the 5″ wide by 1″ high opening. The hand truck attachment 222 acts as a pair of gripping fingers that form a 0.250″ wide by 3″ deep slot which slips on to a hand truck toe plate 202, the slot is formed by two opposing 45° bends to form a 0.125″ offset in each of the two sheets such that a gap is created at the lower end of the adapter apparatus and a 45° bend vee shaped cradle at the top which is the ladder rung support 223, ending with the horizontal ladder side rail support 226 formed by a 190° bend at a ⅜″ radius. The multi-mode ladder support allows ladders to be carried by the rung/step or the side rail, while raising the ladder high enough to clear the front edge of the hand truck toe plate and center its weight directly over the hand trucks 201 one or more wheels, reducing the weight lifted by the user to near zero. The top portion of the hand truck attachment 222 contains two formed projections, that act as a pair of stops to prevent the hand truck toe plate 202 from creating a spreading force on the fingers due to the downward force from the weight of the ladder and the hand truck toe plate 202 wedging upward between the two sheets of steel. Each sheet of steel has one projection, 0.500″ wide, that slides in to a rectangular opening within the other sheet, forming a rigid pair of stops. The hand truck attachment 222 grips the hand truck toe plate 202 by pinching and binding action due to the weight being off center, allowing it to grip various thicknesses of hand truck toe plates 202. The ladder rung support 223 is a vee shaped cradle, 1.5″ deep, that supports the ladder rung or a step ladder step. A single ladder 205 FIG. 7, extension ladder or step ladder 206 may be carried by one ladder rung or step using the ladder rung support 223. Multiple ladders may be stacked one on top of the other and bound together with a bungee strap 207. The top edges of the ladder rung support 223 have a curved surface that forms the horizontal ladder side rail support 226, this supports a ladder tipped on its side as shown in FIGS. 8-9. The curved surface is able to provide a suitable support surface without regard to the pitch angle of the ladder, which changes depending on the length of the hand truck frame on which the adapter apparatus is attached. When carrying one or more ladders 206 on its side as illustrated in FIGS. 8-9, one or both vertical ladder supports 227, made from 0.500″ diameter×21″ long steel rod with 2″ diameter eye bent at one end, provide additional stability while applying a bungee strap 207 and while transporting the ladder 206. Each vertical ladder support 227 is removably attached to the sheet steel by insertion in to a vertical ladder support socket 228 and held in place by hair pin 230 which pierces the vertical ladder support socket 228 and vertical ladder supports 227. A first vertical ladder support socket 228, made from 0.750″ outside diameter×0.120″ wall thickness×4″ long round steel tubing, is positioned upright at one side of the device, then welded to the horizontal ladder side rail support 226 and the hand truck attachment 222. A second vertical ladder support socket 228 is positioned upright at 2″ from the opposite side of the device, then welded to the horizontal ladder side rail support 226 and the hand truck attachment 222. A 5″ wide by 1″ high rectangular opening between the hand truck attachment 222 and the ladder rung support 223, centered from left to right, to allow the bungee strap 207 to completely wrap around the ladder rung, securing it tightly to both the adapter apparatus and the hand truck 201. Eight non-critical location holes, 5/16″ diameter are drilled in the ladder rung support 223 as shown to provide additional, optional places for attaching bungee straps 207. Four non-critical location holes, ¼″ diameter are drilled in the hand truck attachment 222 as shown to provide additional, optional places for attaching bungee straps 207. Any material with enough strength to support one or more ladders safely may be used in place of the steel, some examples are aluminum, copper, bronze, brass, stainless steel, magnesium, titanium, carbon fiber, fiberglass resin, plastic, wood, bamboo, 3D printing with new exotic materials. The nut and bolt could be replaced with a rivet or other fastener, or it could be hot or cold welded, or it could be crimped by folding the material of one sheet around to the front of the other sheet as shown in FIGS. 56-60. While FIGS. 8-9 show a step ladder being carried on its side rail, any other type ladder could also be carried on its side. Carrying a ladder in this manner enables you to maneuver through smaller passages and doorways, especially when moving a wide step ladder. Bungee strap 207 could be replaced with an integrated clamp, spring, U-bolt or strap. A 0.250″ thick plate of material sandwiched between the two sheets could replace where the slot is formed by two opposing 45° bends to form a 0.125″ offset in each of the two sheets such that a 0.250″ gap is created at the lower end of the adapter apparatus. In other words, you could omit the two opposing 45° bends and instead use a 0.250″ thick plate of material sandwiched between the two sheets to create the 0.250″ gap.

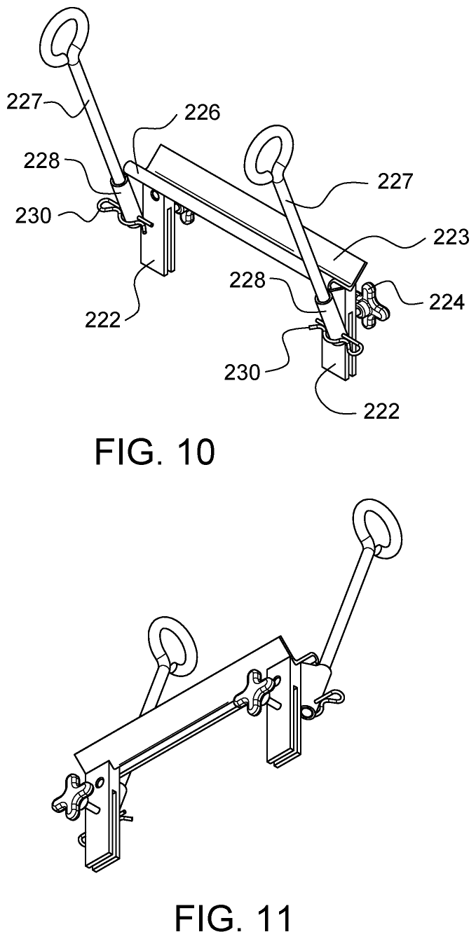

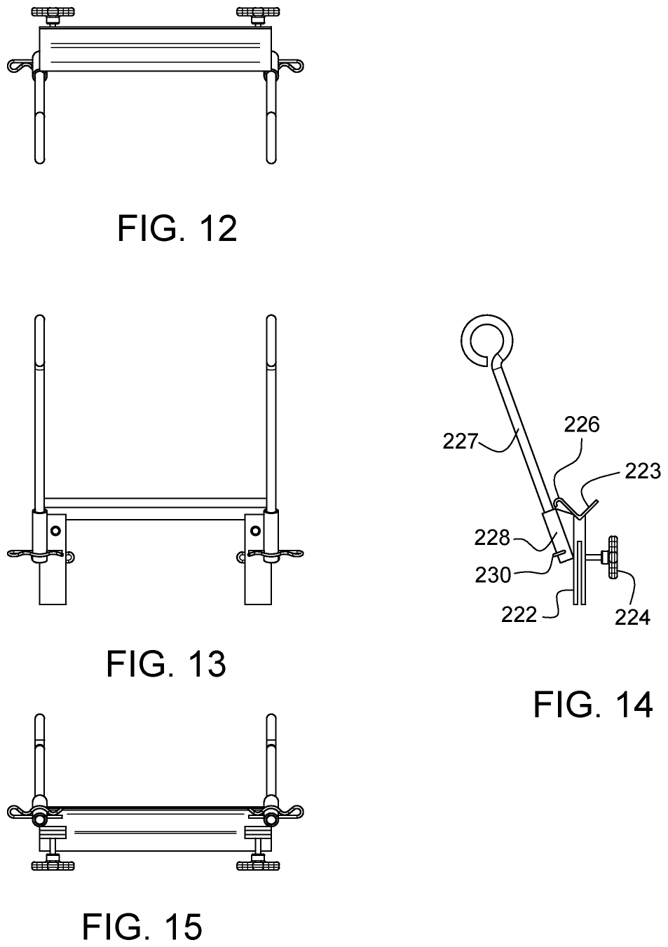

FIGS. 10-15 illustrate another embodiment of the adapter apparatus 221 and is removably installed. The ladder rung support 223 is made from angle iron 1.25″×2″×0.125″ thick by 11″ long with the tip of the 2″ leg bent 170° to form the horizontal ladder side rail support 226. Each vertical ladder support 227 is made from 0.500″ diameter by 17″ long steel rod with 2″ diameter eye bent at one end. Each vertical ladder support 227 is removably attached to the device by insertion in to a vertical ladder support socket 228 and held in place by hair pin 230 which pierces the vertical ladder support socket 228 and vertical ladder support 227. Each vertical ladder support socket 228 has a mounting flange that is welded to each hand truck attachment 222. Each hand truck attachment 222 is made from 1.25″×0.75″×4″ long rectangle steel bar, slotted from the bottom, 3″ deep on center, drill and tap ⅜″-16 located ½″ below top of slot on center to receive screw clamp 224, drill and tap ⅜″-16 located ½″ below top of hand truck attachment 222 on center for additional attachments, such as a means for hanging the adapter apparatus on the hand truck 201 while not using it as a ladder dolly. Screw clamp 224 shown with a hand knob, provides a supplementary method of attaching the adapter apparatus to a hand truck 201. Alternately the ladder rung support 223 could be made from angle iron 1.25″×1.25″×0.125″ thick by 11″ long and replace the 170° bend with a welded in place ¾″ diameter×0.125″ wall thickness×11″ long steel pipe to form the horizontal ladder side rail support 226.

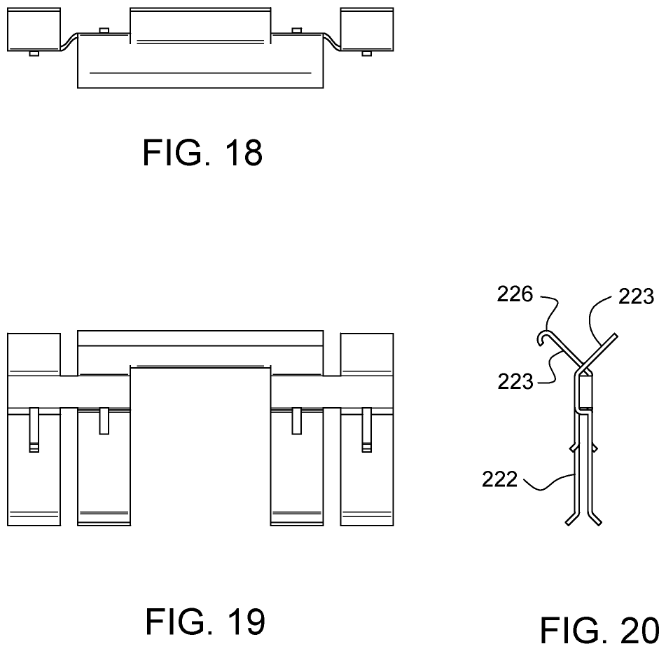

FIGS. 16-20 illustrate another embodiment of the adapter apparatus 221 and is removably installed. This embodiment is made from one piece of sheet steel 11″ wide×0.125″ thickness, formed with various angles and steps as shown. The various labeled parts perform the same functions as the previous embodiments.

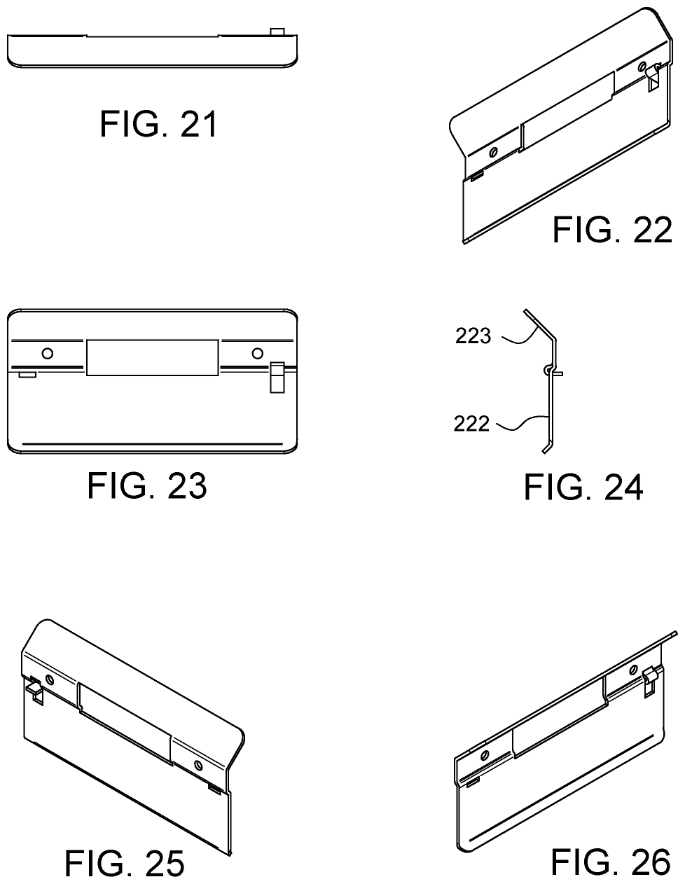

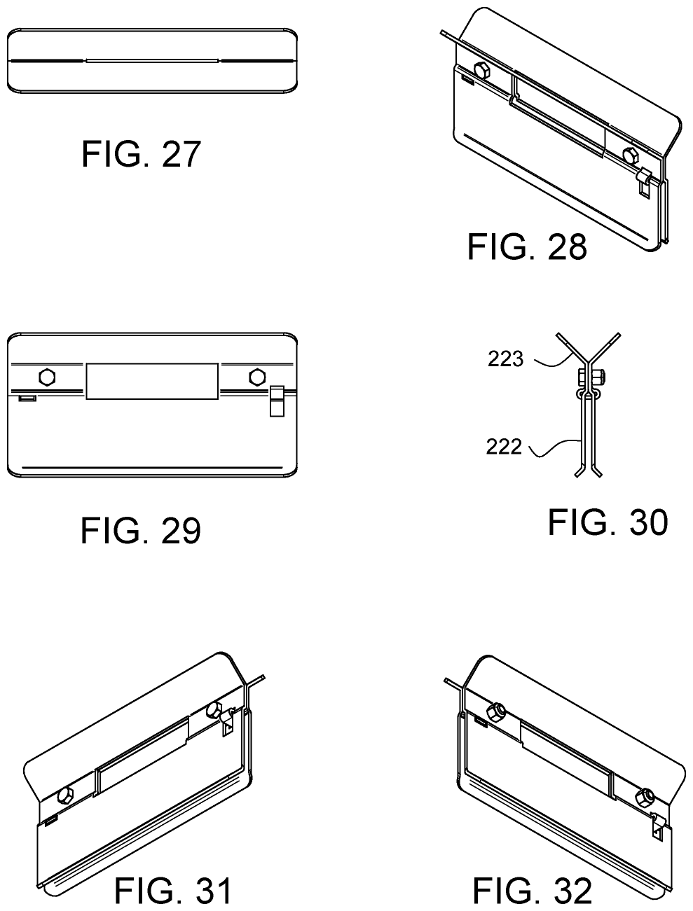

FIGS. 21-32 illustrate another embodiment of the adapter apparatus 221 and is removably installed. This embodiment is made from two pieces of sheet steel 11″ wide by 0.125″ thickness, formed with various angles and steps as shown. The various labeled parts perform the same functions as the previous embodiments. FIGS. 21-26 illustrate various views of one of the two identical sheets. FIGS. 27-32 illustrate various views of the two identical sheets fully assembled.

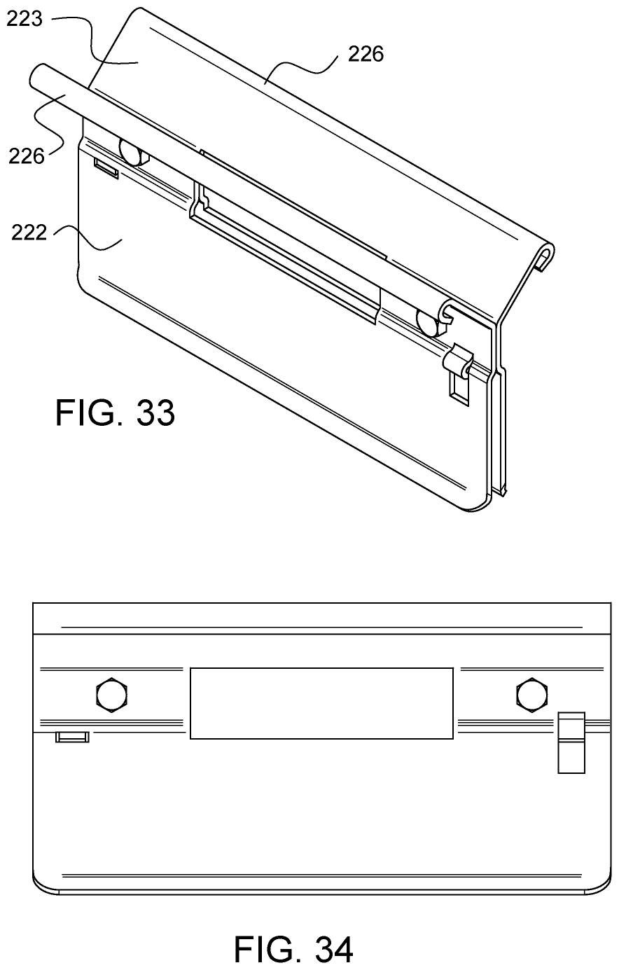

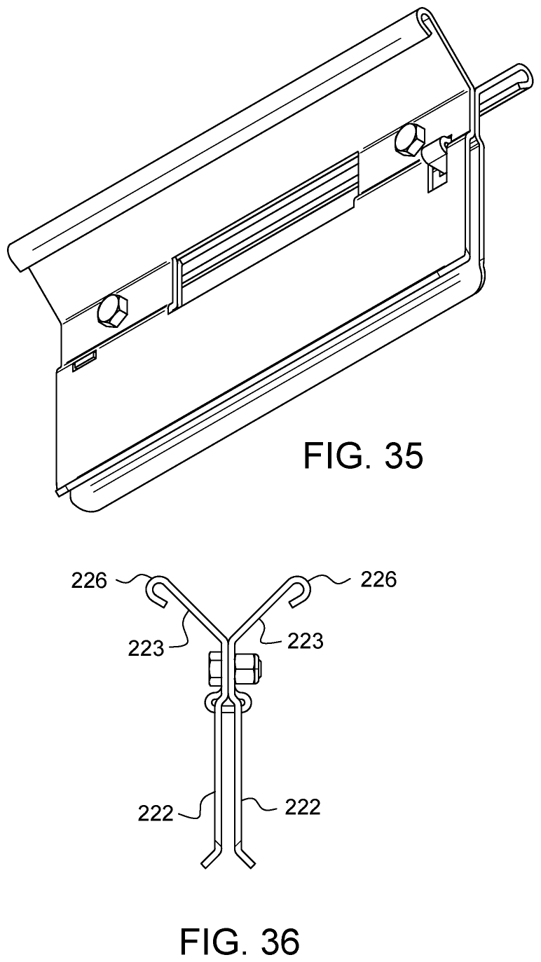

FIGS. 33-36 illustrate another embodiment of the adapter apparatus 221 and is removably installed. This embodiment is made from two pieces of sheet steel 11″ wide by 0.125″ thickness, formed with various angles and steps as shown. The various labeled parts perform the same functions as the previous embodiments. This embodiment is similar to the embodiment illustrated in FIGS. 1-5 except for the vertical ladder supports 227 and associated components have been omitted.

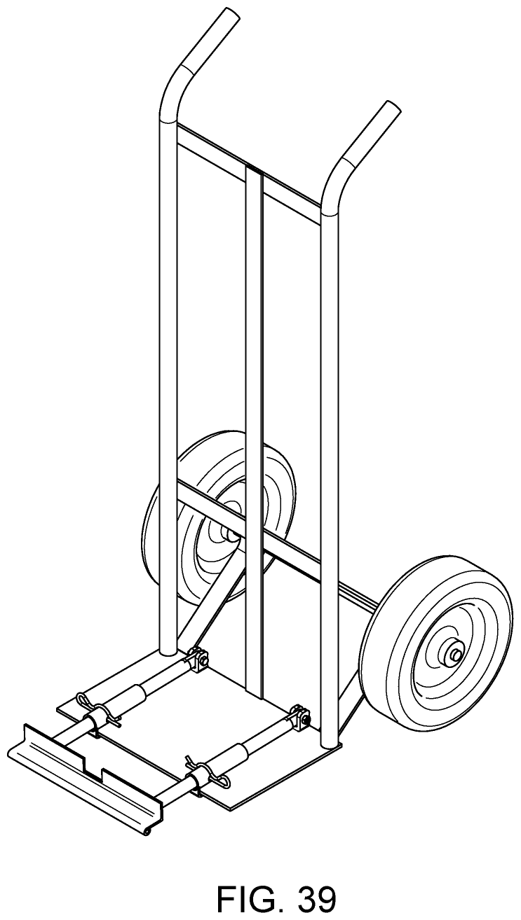

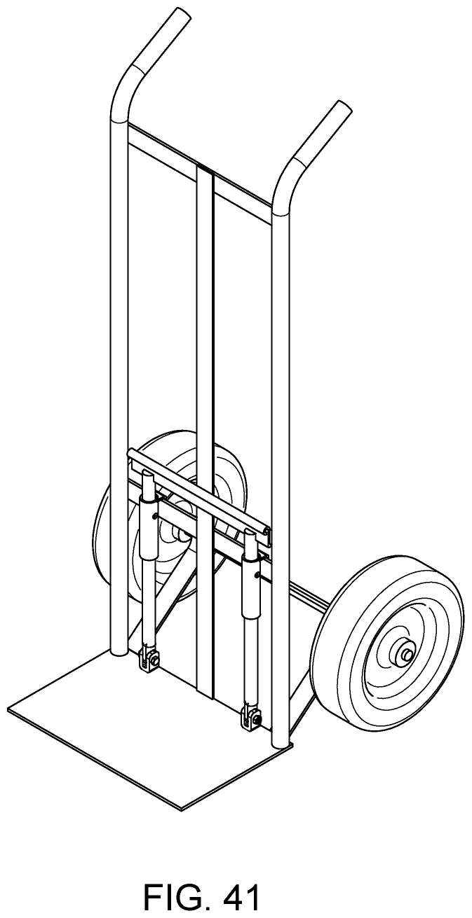

FIGS. 37-38 illustrate another embodiment of the adapter apparatus 221 and is permanently installed. The various labeled parts perform the same functions as the previous embodiments. FIG. 37 Hand truck attachment 222, consists of two each hairpin clip 230, two each support arm 232, two each support arm latch 233, two each support arm pivot 234, two each ¼″-20 bolt and lock nut. Support arm pivot 234 is welded to the hand truck toe plate 202 by the manufacturer, support arm 232 is bolted to Support arm pivot 234 using a ¼″-20 bolt and lock nut, support arm latch 233 can rotate and slide up and down support arm 232, hairpin clip 230 can lock support arm latch 233 in one of two positions. Lock the device in the down position to use the hand truck 201 as a ladder dolly, see FIGS. 39-40. Lock the device in the up position to use the hand truck 201 normally, see FIGS. 41-42. Alternately, support arm pivot 234 could be welded to the hand truck frame by the manufacturer. Another alternate method of attachment could be; omit support arm pivot 234 and modify support arm 232 by omitting the two flats, drill a ¼″ hole through the hand truck frame aligned with existing ¼″ hole in support arm 232, insert a ¼″-20 bolt through the drilled hole in the hand truck frame and support arm 232, apply a lock nut tight enough to allow the assembly to pivot on the said bolt.

FIGS. 43-46 illustrate another embodiment of the adapter apparatus 221 and is removably installed. This embodiment is similar to the embodiment illustrated in FIG. 10 except for the vertical ladder support socket 228 is in a different location, welded to the back, outside edge of the hand truck attachment 222.

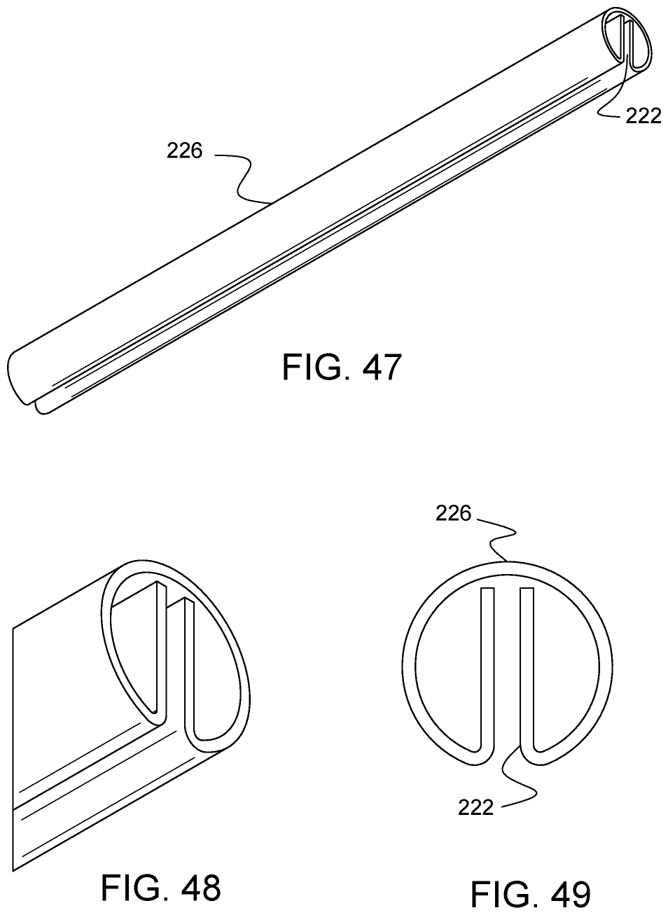

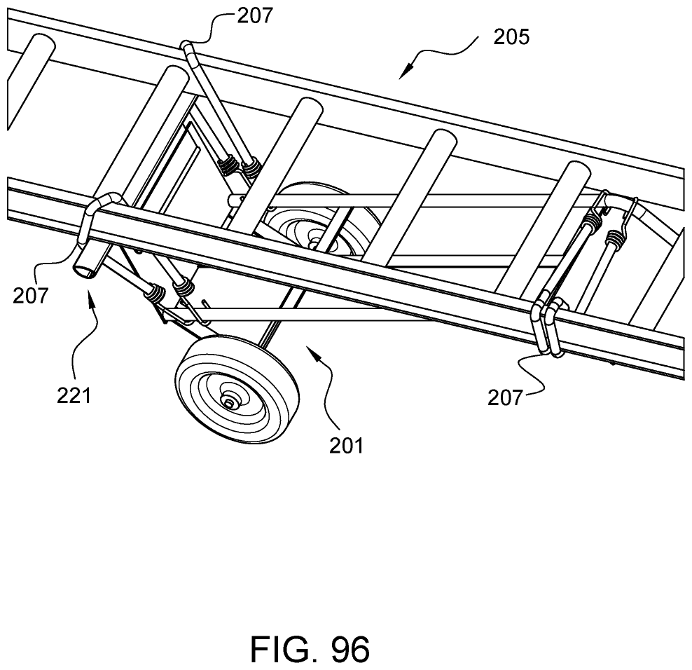

FIGS. 47-49 illustrate another embodiment of the adapter apparatus 221 and is removably installed. This embodiment is made from one piece of sheet steel 24″ wide by 0.125″ thickness, formed as shown. The horizontal ladder side rail support 226 is a 2″ diameter tubular shape by 24″ long. The hand truck attachment 222 is a pair of internal 1.75″ long gripping fingers, which form a 0.250″ wide by 1.750″ deep slot. The various labeled parts perform the same functions as the previous embodiments. The hand truck attachment 222 grips the hand truck toe plate 202, while the horizontal ladder side rail support 226 supports the ladder by one or both side rails. See FIG. 96 for a single ladder 205 supported on both side rails using a similar embodiment of the adapter apparatus 221.

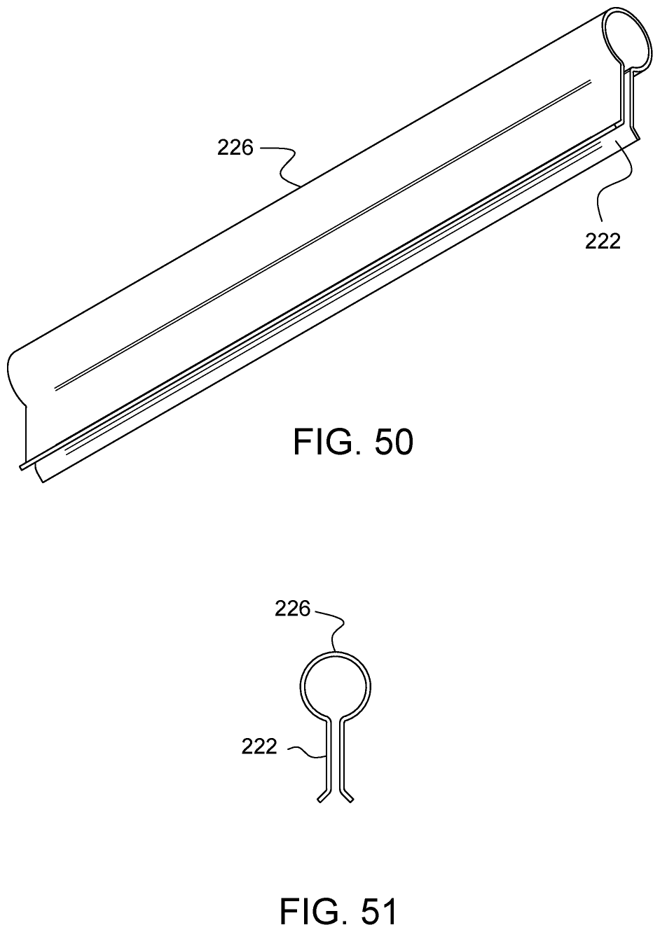

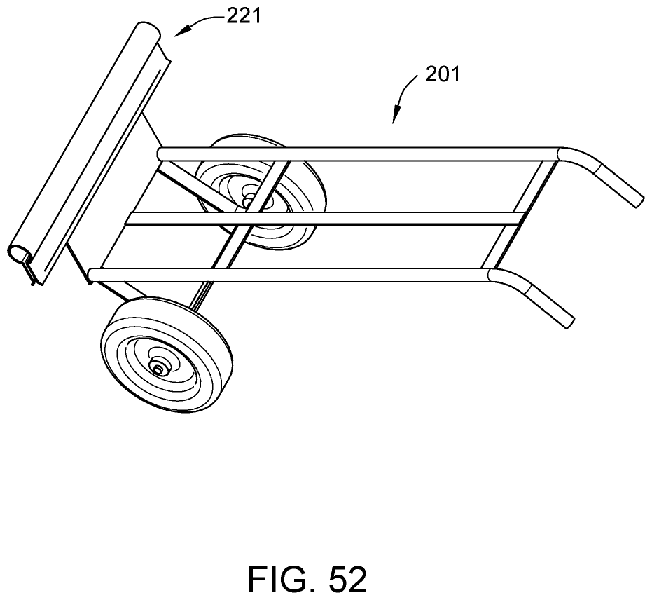

FIGS. 50-51 illustrate another embodiment of the adapter apparatus 221 and is removably installed. This embodiment is made from one piece of sheet steel 24″ wide×0.125″ thickness, formed as shown. The horizontal ladder side rail support 226 is a 2″ diameter tubular shape by 24″ long. The hand truck attachment 222 is a pair of external 2″ long gripping fingers, which form a 0.250″ wide by 2″ deep slot. The last 0.250″ of the bottom end of each finger has a 45° bend to aid assembly to a hand truck toe plate 202. The various labeled parts perform the same functions as the previous embodiments. The hand truck attachment 222 grips the hand truck toe plate 202, while the horizontal ladder side rail support 226 supports the ladder by one or both side rails. FIG. 52 illustrates this embodiment attached to a hand truck 201. See FIG. 96 for a single ladder 205 supported on both side rails using a similar embodiment of the adapter apparatus 221.

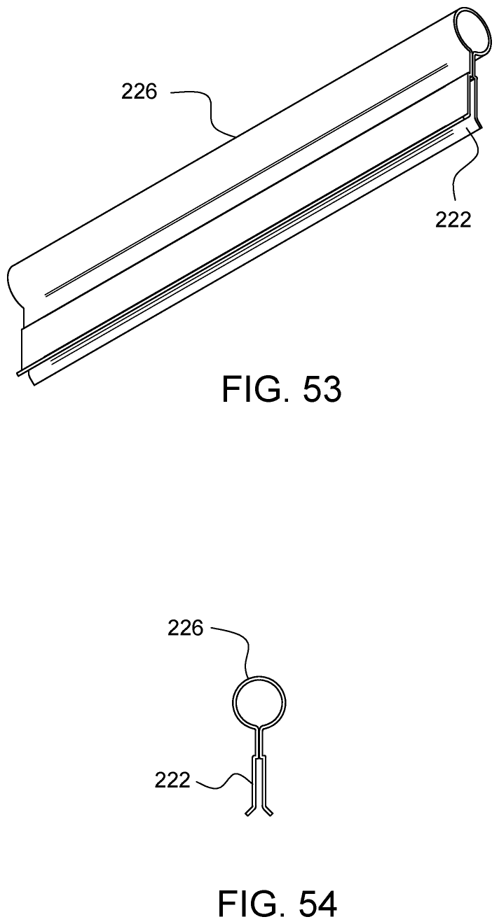

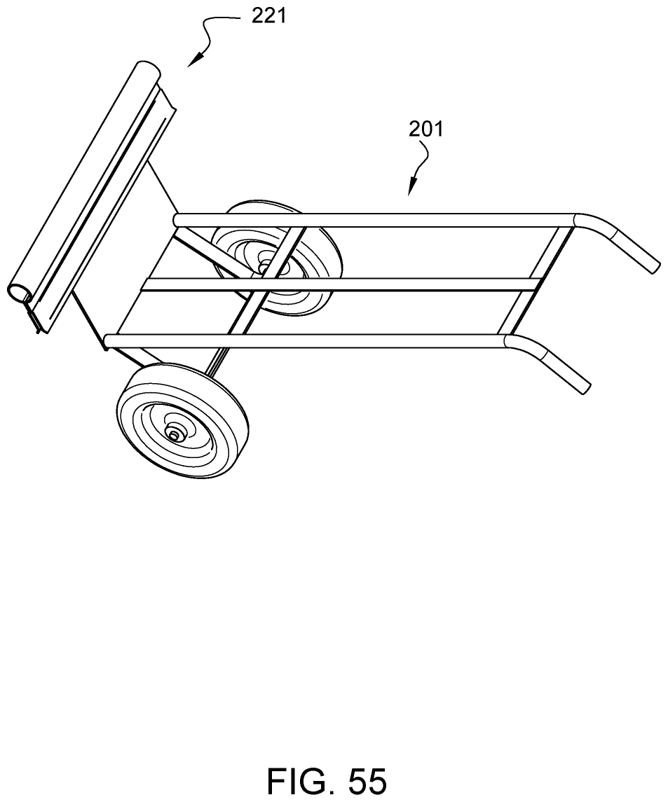

FIGS. 53-54 illustrate another embodiment of the adapter apparatus 221 and is removably installed. This embodiment is made from one piece of sheet steel 24″ wide×0.125″ thickness, formed as shown. The horizontal ladder side rail support 226 is a 2″ diameter tubular shape by 24″ long. The hand truck attachment 222 is a pair of external 2″ long gripping fingers, which form a 0.250″ wide by 2″ deep slot. The last 0.250″ of the bottom end of each finger has a 45° bend to aid assembly to a hand truck toe plate 202. Just below the horizontal ladder side rail support 226, the two sides of sheet steel come together and touch each other for a length of 1.5″ before forming the hand truck attachment 222. This raises the height of the horizontal ladder side rail support 226 in relation to the ground by approximately 3.5″, providing greater ground clearance for the ladder. The various labeled parts perform the same functions as the previous embodiments. The hand truck attachment 222 grips the hand truck toe plate 202, while the horizontal ladder side rail support 226 supports the ladder by one or both side rails. FIG. 55 illustrates this embodiment attached to a hand truck 201. See FIG. 96 for a single ladder 205 supported on both side rails using a similar embodiment of the adapter apparatus 221.

FIGS. 56-59 illustrate another embodiment of the adapter apparatus 221 and is removably installed. This embodiment is made from one piece of sheet steel 11″ wide×0.125″ thickness, formed as shown. The various labeled parts perform the same functions as the previous embodiments. The area between the ladder rung support 223 and the hand truck attachment 222 has additional material at the edges of one face only, which is folded around the material of the second face and crimped to provide a solid structure, see FIG. 59. FIG. 60 illustrates this embodiment attached to a hand truck 201. See FIG. 171 for man pulling a single ladder 205 supported on the ladder rung support 223 using a similar embodiment of the adapter apparatus 221.

FIGS. 61-62 illustrate another embodiment of the adapter apparatus 221 and is removably installed. This embodiment is made from one piece of sheet steel 11″ wide×0.125″ thickness, formed as shown. The various labeled parts perform the same functions as the previous embodiments. The ladder rung support 223 uses a vee shaped cradle.

FIGS. 63-64 illustrate another embodiment of the adapter apparatus 221 and is removably installed. This embodiment is made from one piece of sheet steel 11″ wide×0.125″ thickness, formed as shown. The various labeled parts perform the same functions as the previous embodiments. The ladder rung support 223 uses an arc shaped cradle.

FIGS. 65-66 illustrate another embodiment of the adapter apparatus 221 and is removably installed. This embodiment is made from one piece of sheet steel 11″ wide×0.125″ thickness, formed as shown. The various labeled parts perform the same functions as the previous embodiments. The ladder rung support 223 uses a rectangle shaped cradle.

FIGS. 65-66 illustrate another embodiment of the adapter apparatus 221 and is removably installed. This embodiment is made from one piece of sheet steel 11″ wide×0.125″ thickness, formed as shown. The various labeled parts perform the same functions as the previous embodiments. The ladder rung support 223 uses a rectangle shaped cradle.

FIGS. 67-68 illustrate another embodiment of the adapter apparatus 221 and is removably installed. This embodiment is made from one piece of sheet steel 14″ wide×0.125″ thickness, formed as shown. The various labeled parts perform the same functions as the previous embodiments. The ladder rung support 223 uses a rectangle shaped cradle that hangs below the top edge of the hand truck toe plate 202, see FIG. 69.

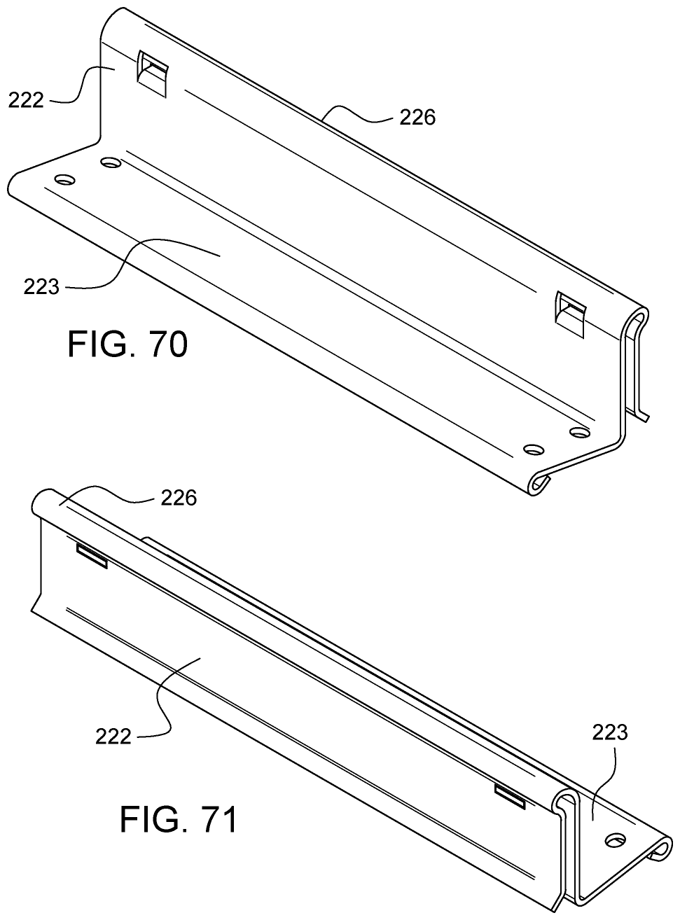

FIGS. 70-71 illustrate another embodiment of the adapter apparatus 221 and is removably installed. This embodiment is made from one piece of sheet steel 14″ wide×0.125″ thickness, formed as shown. The various labeled parts perform the same functions as the previous embodiments. The ladder rung support 223 uses an “L” shaped cradle that hangs below the top edge of the hand truck toe plate 202. Near the top of the hand truck attachment 222, on each side, there is a steel projection, 0.500″ wide, that slides in to a rectangular opening within the other side, forming a rigid pair of stops for the hand truck toe plate 202.

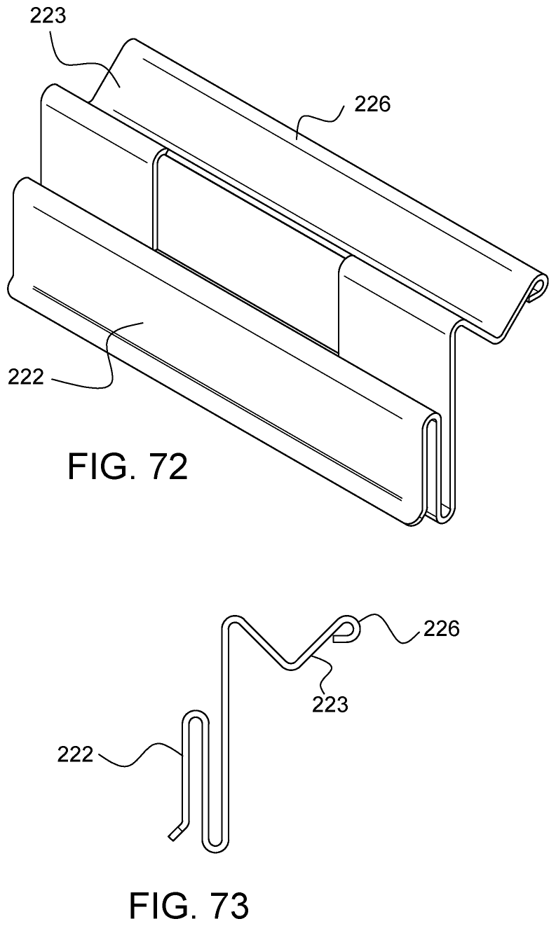

FIGS. 72-73 illustrate another embodiment of the adapter apparatus 221 and is removably installed. This embodiment is made from one piece of sheet steel 11″ wide×0.125″ thickness, formed as shown. The various labeled parts perform the same functions as the previous embodiments. FIG. 74 illustrates this embodiment attached to a hand truck 201.

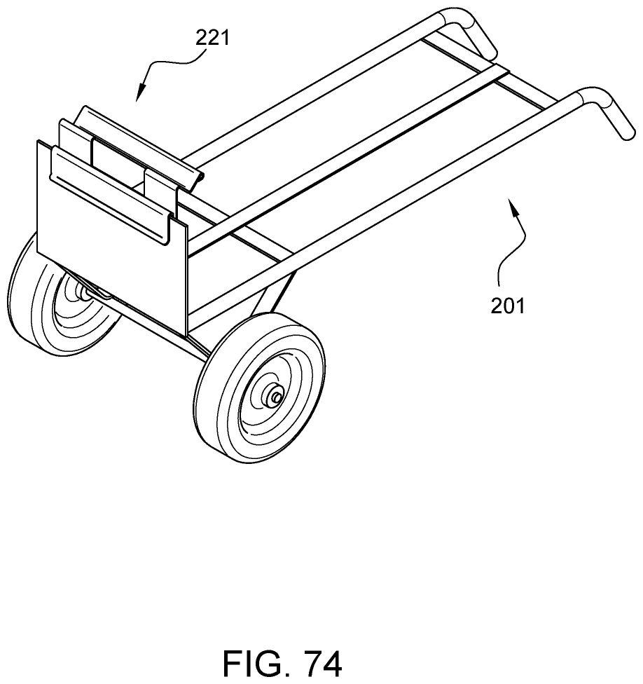

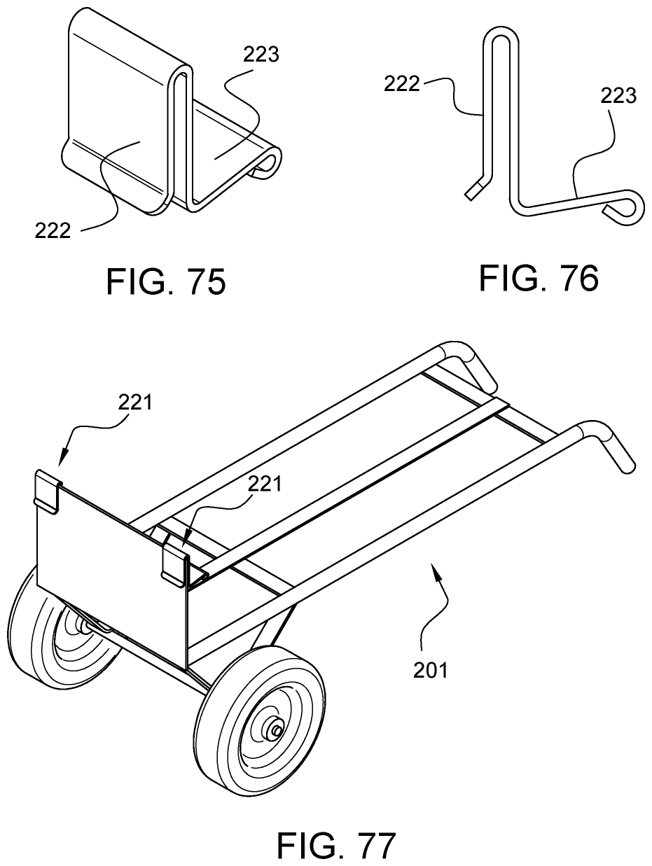

FIGS. 75-76 illustrate another embodiment of the adapter apparatus 221 and is removably installed. This embodiment consists of two pieces, each made from one piece of sheet steel 2″ wide×0.125″ thickness, formed as shown. The various labeled parts perform the same functions as the previous embodiments. The ladder rung support 223 uses an “L” shaped cradle that hangs below the top edge of the hand truck toe plate 202. FIG. 77 illustrates this embodiment attached to a hand truck 201.

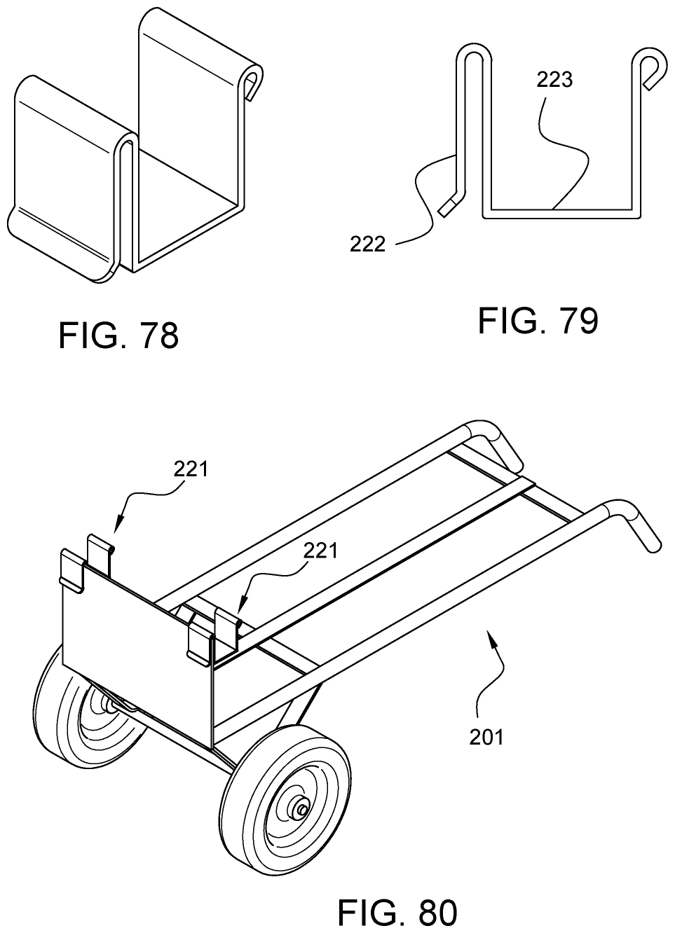

FIGS. 78-79 illustrate another embodiment of the adapter apparatus 221 and is removably installed. This embodiment consists of two pieces, each made from one piece of sheet steel 2″ wide×0.125″ thickness, formed as shown. The various labeled parts perform the same functions as the previous embodiments. The ladder rung support 223 uses a rectangle shaped cradle that hangs below the top edge of the hand truck toe plate 202. FIG. 80 illustrates this embodiment attached to a hand truck 201.

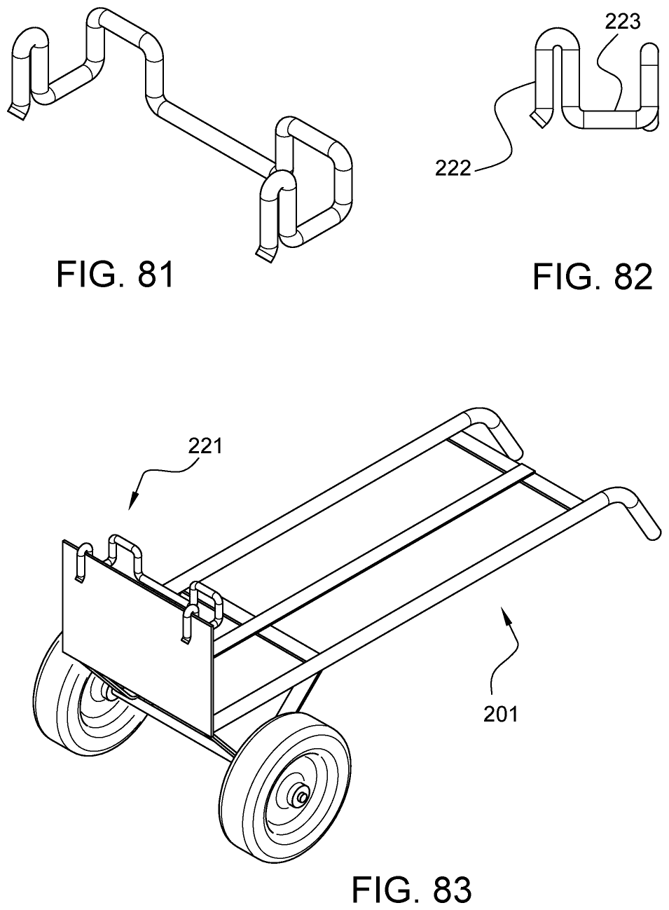

FIGS. 81-82 illustrate another embodiment of the adapter apparatus 221 and is removably installed. This embodiment is made from one piece of round steel bar 0.500″ diameter, formed as shown. The various labeled parts perform the same functions as the previous embodiments. The ladder rung support 223 uses a rectangle shaped cradle that hangs below the top edge of the hand truck toe plate 202. FIG. 83 illustrates this embodiment attached to a hand truck 201.

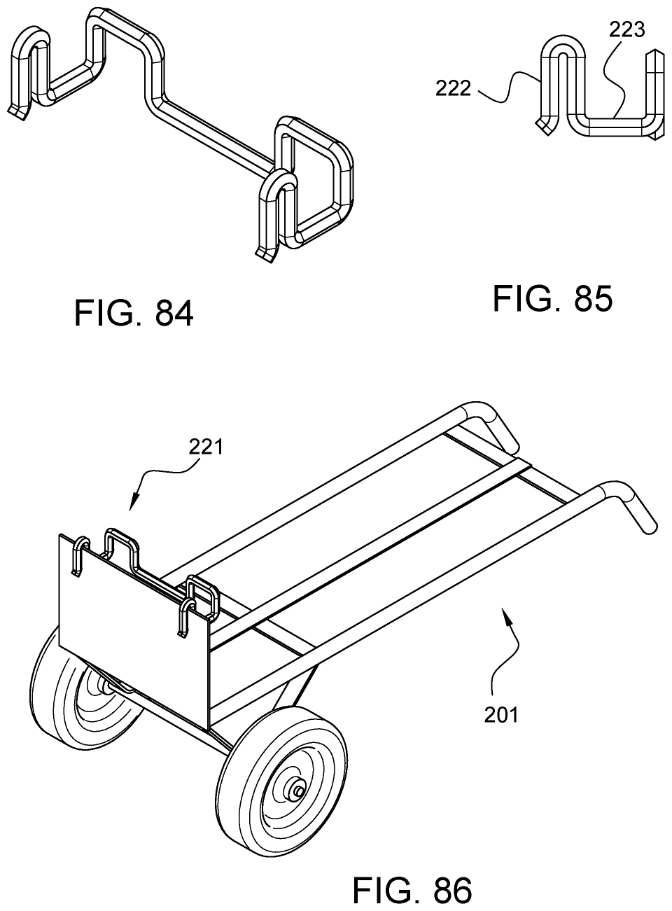

FIGS. 84-85 illustrate another embodiment of the adapter apparatus 221 and is removably installed. This embodiment is made from one piece of hexagonal steel bar 0.500″ across flats, formed as shown. The various labeled parts perform the same functions as the previous embodiments. The ladder rung support 223 uses a rectangle shaped cradle that hangs below the top edge of the hand truck toe plate 202. FIG. 86 illustrates this embodiment attached to a hand truck 201.

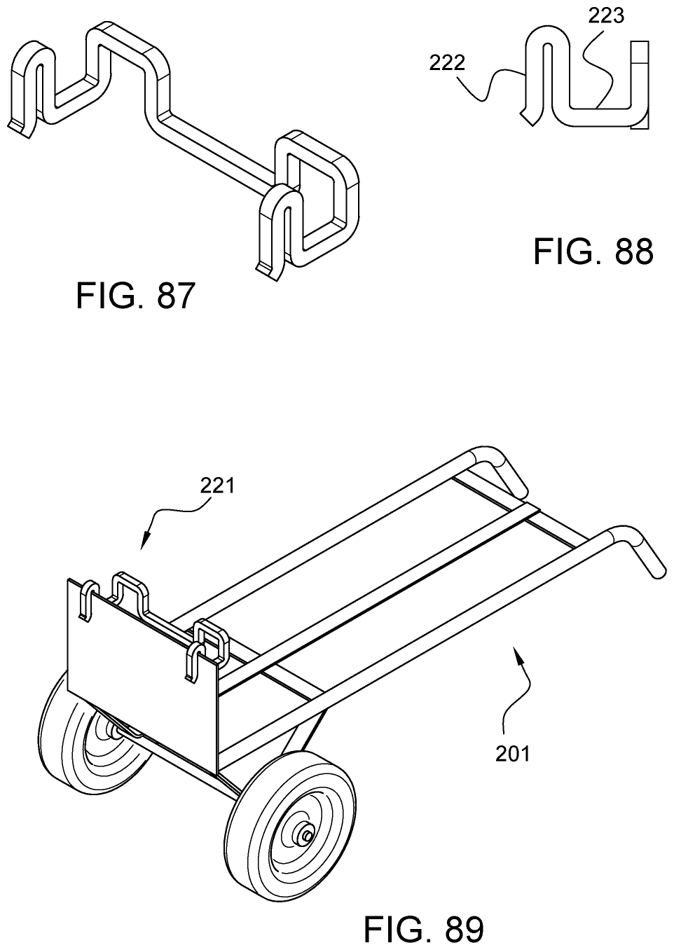

FIGS. 87-88 illustrate another embodiment of the adapter apparatus 221 and is removably installed. This embodiment is made from one piece of square steel bar 0.500″ across flats, formed as shown. The various labeled parts perform the same functions as the previous embodiments. The ladder rung support 223 uses a rectangle shaped cradle that hangs below the top edge of the hand truck toe plate 202. FIG. 89 illustrates this embodiment attached to a hand truck 201.

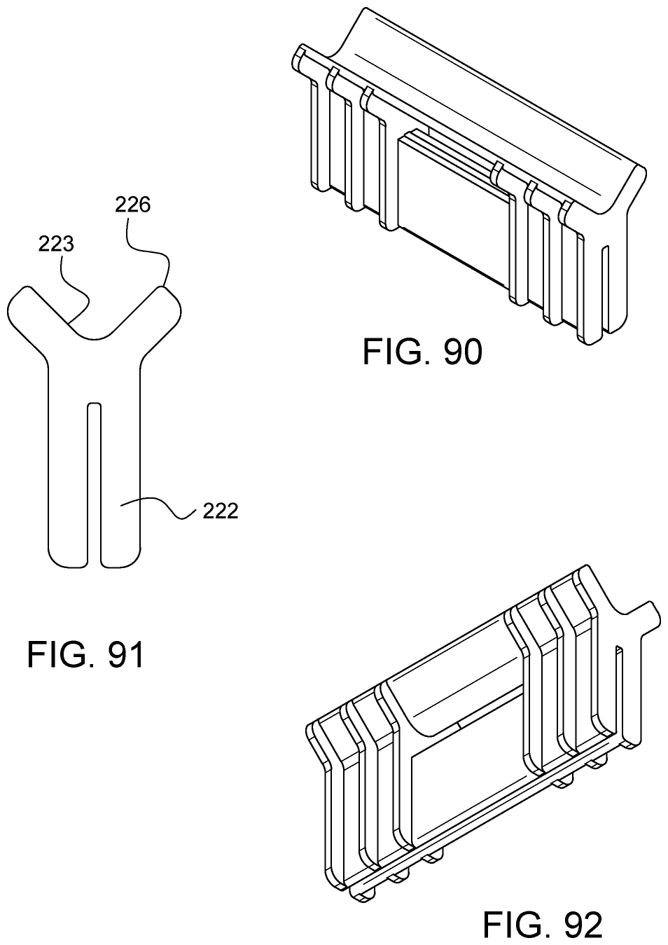

FIGS. 90-92 illustrate another embodiment of the adapter apparatus 221 and is removably installed. This embodiment is made from plastic, molded as shown with six reinforcement ribs each side and draft angle as required when molding plastic, also includes 5″×1″ rectangle opening for bungee strap 207. The various labeled parts perform the same functions as the previous embodiments.

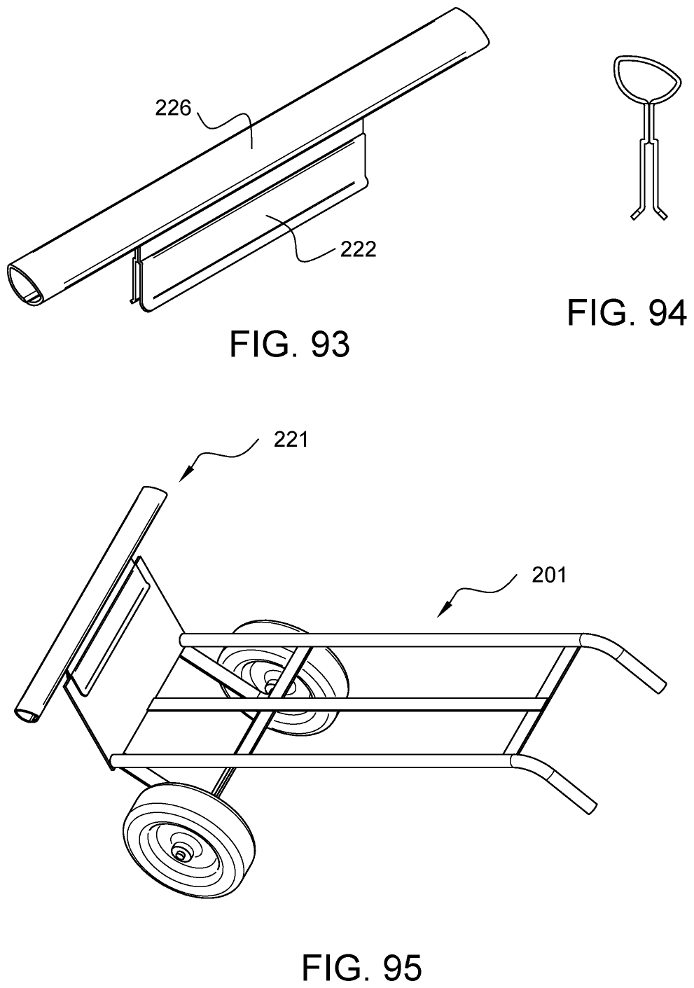

FIGS. 93-94 illustrate another embodiment of the adapter apparatus 221 and is removably installed. This embodiment is made from one piece of sheet steel 24″ wide×0.125″ thickness, formed as shown. The horizontal ladder side rail support 226 is 180° of 1″ radius blending to a 4″ radius for the remainder 180° tubular shape by 24″ long. The hand truck attachment 222 is a pair of external 2″ long gripping fingers, which form a 0.250″ wide×2″ deep slot. The last 0.250″ of the bottom end of each finger has a 45° bend to aid assembly to a hand truck toe plate 202. The various labeled parts perform the same functions as the previous embodiments. The hand truck attachment 222 grips the hand truck toe plate 202, while the horizontal ladder side rail support 226 supports the ladder by one or both side rails. FIG. 95 illustrates this embodiment attached to a hand truck 201. FIG. 96 illustrates this embodiment attached to a hand truck 201 with a single ladder 205 supported on both sides.

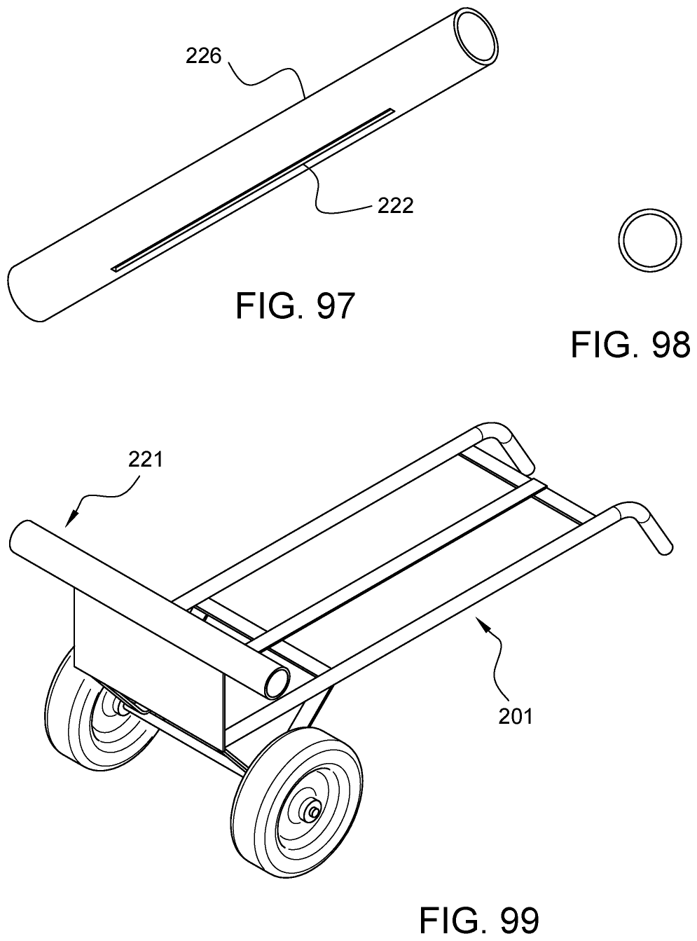

FIGS. 97-98 illustrate another embodiment of the adapter apparatus 221 and is removably installed. This embodiment is made from one piece of 2″ outside diameter×0.125″ wall thickness×24″ long steel tubing with a centered slot measuring 0.250″ wide×14″ long through one wall as shown. The various labeled parts perform the same functions as the previous embodiments. The hand truck attachment 222 grips the hand truck toe plate 202, while the horizontal ladder side rail support 226 supports the ladder by one or both side rails. FIG. 99 illustrates this embodiment attached to a hand truck 201.

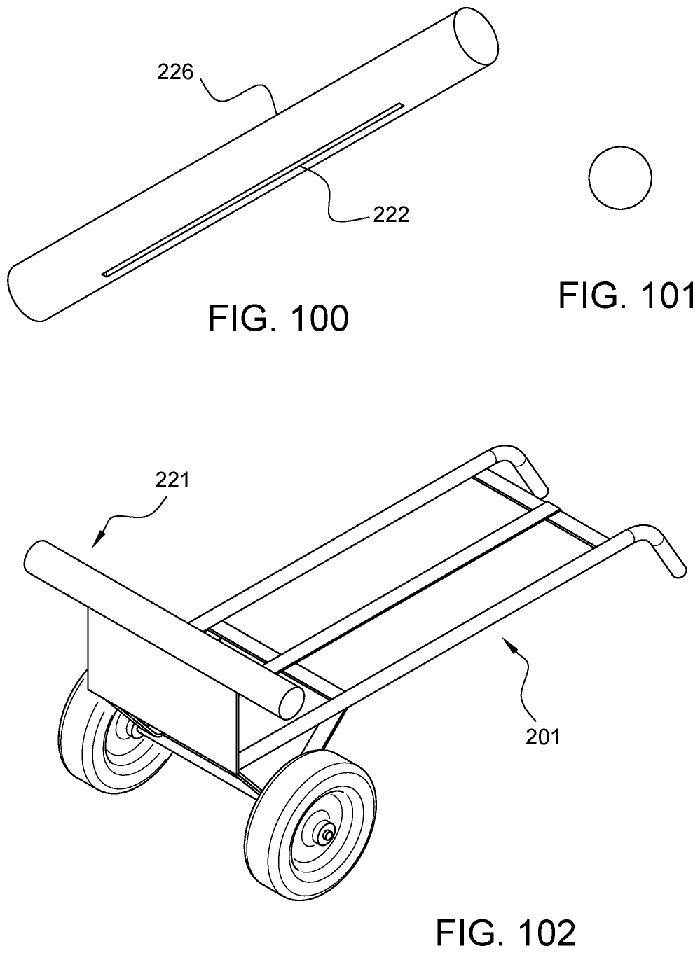

FIGS. 100-101 illustrate another embodiment of the adapter apparatus 221 and is removably installed. This embodiment is made from one piece of 2″ diameter×24″ long steel rod with a centered slot measuring 0.250″ wide×1.875″ deep×14″ long as shown. The various labeled parts perform the same functions as the previous embodiments. The hand truck attachment 222 grips the hand truck toe plate 202, while the horizontal ladder side rail support 226 supports the ladder by one or both side rails. FIG. 102 illustrates this embodiment attached to a hand truck 201.

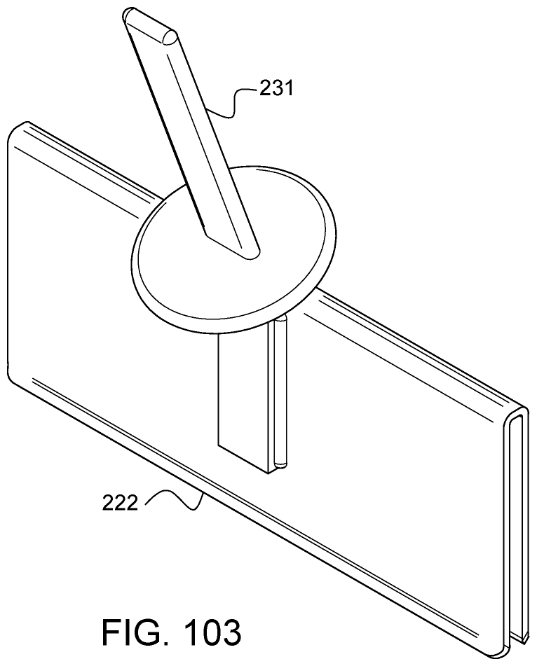

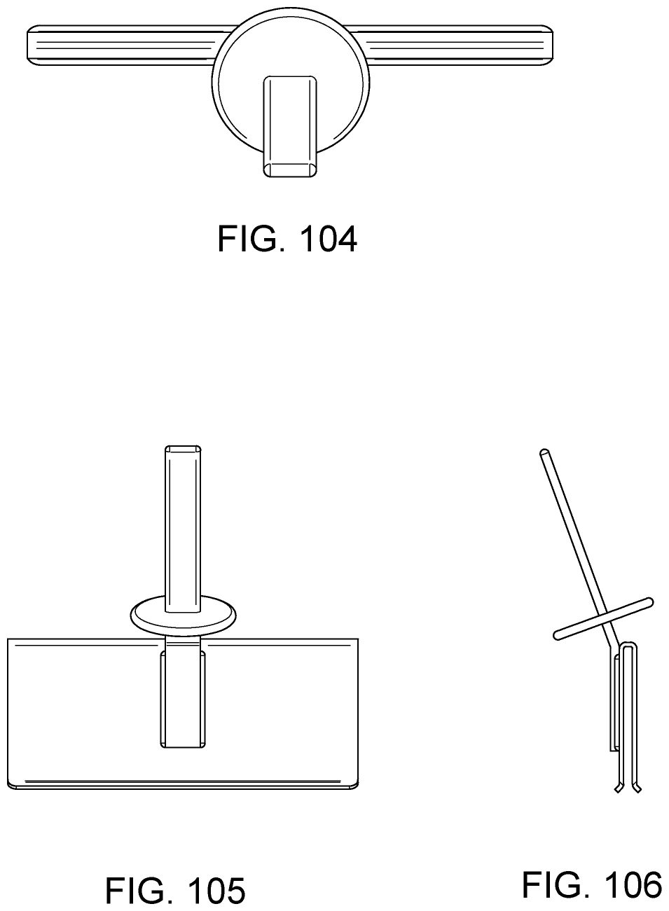

FIGS. 103-106 illustrate another embodiment of the adapter apparatus 221 and is removably installed. Hollow ladder rung support 231 is made from 0.187″ thick×1.5″ wide×7″ long flat steel bar with a 20° bend located 2″ from the lower end, a 2″ diameter×0.187″ thick steel disk is welded 4.5″ from the top of 0.187″ thick×1.5″ wide flat steel bar. The hand truck attachment 222 is made from one piece of sheet steel 11″ wide×0.125″ thickness, bent to form a 0.250″ wide slot that fits over a hand truck toe plate 202. Hollow ladder rung support 231 is welded to the middle of the hand truck attachment 222 as shown. The hand truck attachment 222 grips the hand truck toe plate 202. This embodiment supports a ladder on its side, while the hollow ladder rung support 231 slips inside a hollow rung, selected somewhere near the middle of the ladder, while another part of the ladder makes contact somewhere near the handle end of the hand truck and is tied with a bungee strap 207. The 0.187″ thick×1.5″ wide flat steel bar is able to flex and allows the ladder to pivot on the axis of the hand truck axial, but is much more rigid perpendicular to the hand truck axial. The flex compensates for various hand truck lengths without overly stressing the ladder.

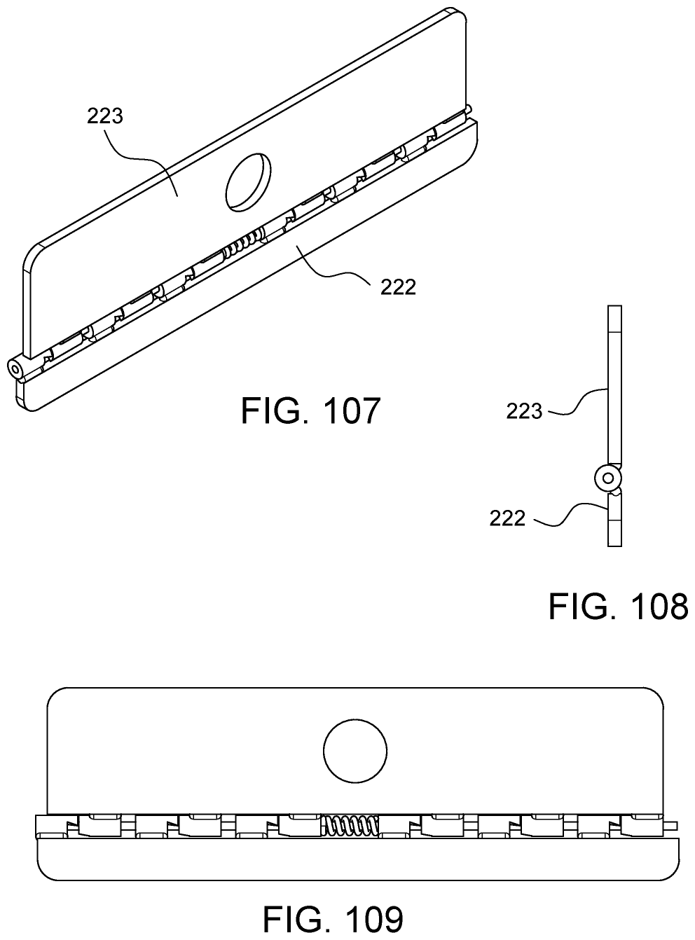

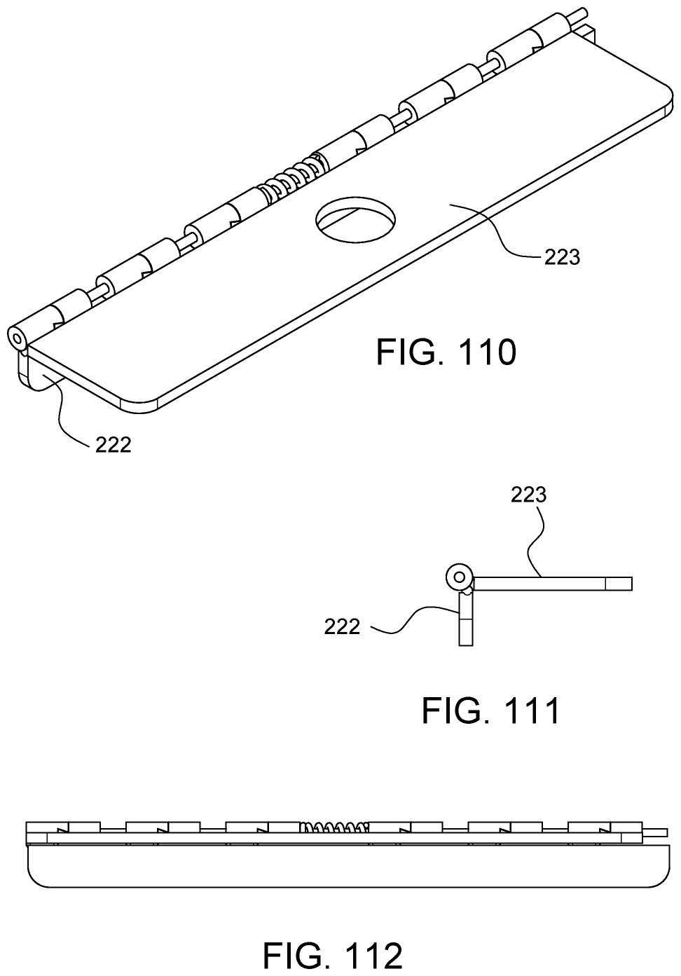

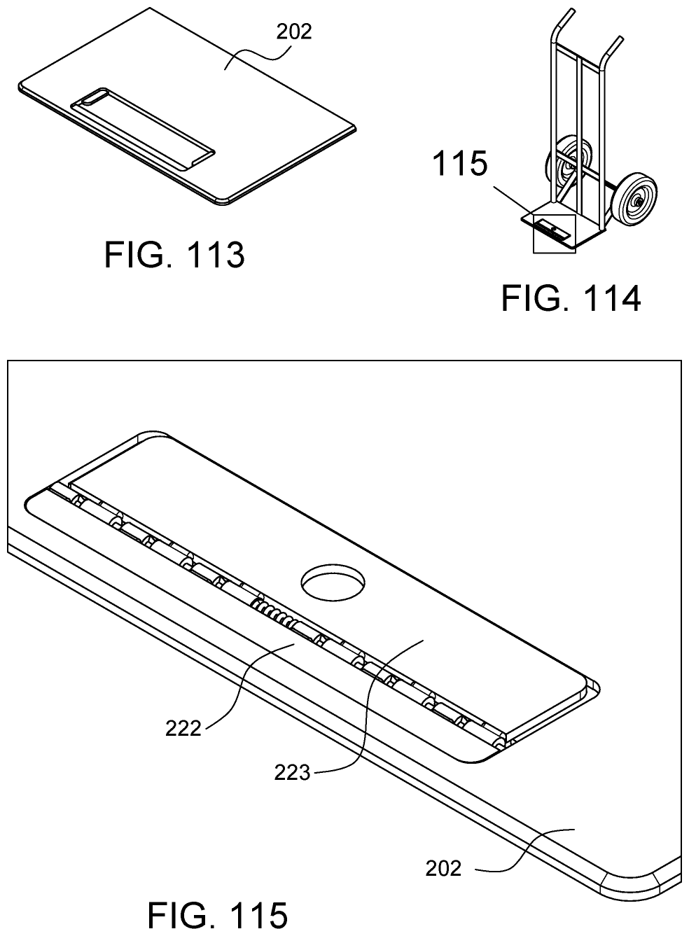

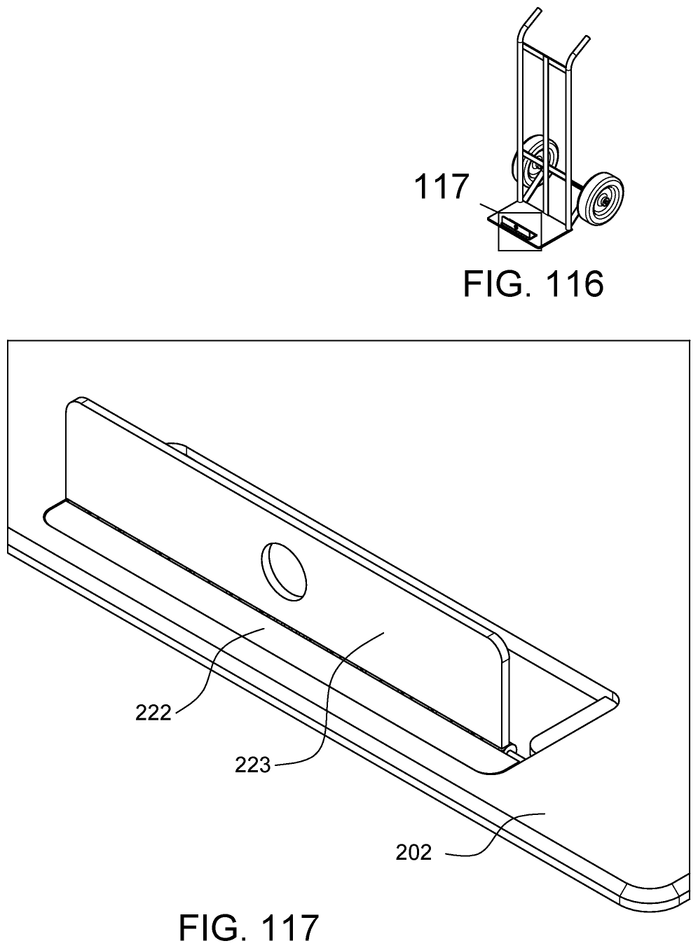

FIGS. 107-117 illustrate another embodiment of the adapter apparatus 221 and is permanently installed. FIGS. 107-109 illustrate the adapter apparatus in the retracted position or hand truck mode. FIGS. 110-112 illustrate the adapter apparatus in the extended position or ladder dolly mode. FIG. 113 illustrates the modified hand truck toe plate 202, which is 0.250″ thick, machined to fit the adapter apparatus, including two side flanges 0.125″ thick that support the adapter apparatus when retracted and one bottom flange 0.125″ thick used as a welded attachment point for the hand truck attachment 222. FIG. 114 illustrates the adapter apparatus installed on a hand truck toe plate 202, in the retracted position, while FIG. 115 is a detail view of FIG. 114. FIG. 116 illustrates the adapter apparatus installed on a hand truck toe plate 202, in the extended position or ladder dolly mode, while FIG. 117 is a detail view of FIG. 116. The ladder rung support 223 is a steel rectangle plate 7.312″×1.5″×0.125″ thick, both upper corners have a ¼″ radius, a ¾″ diameter hole centrally located, welded to six each hinge knuckle sections. Each hinge knuckle section is 0.25′ OD×0.095″ ID×0.625″ long, with 1 helical clutch tooth, 0.125″ deep×20° of hook with 140° of tooth thickness, assembled on a hinge pin measuring 0.093″ OD×7.625″ long. At the center of the hinge pin is a compression spring that forces the clutch teeth to remain engaged while the ladder rung support 223 is extended. The ¾″ diameter hole is a finger hole, used for extending or retracting the ladder rung support 223. The hand truck attachment 222 is a steel rectangle plate 7.625″×0.5″×0.125″ thick, and is welded to the hand truck toe plate 202 and, welded to six each hinge knuckle sections. Each hinge knuckle section is 0.25′ OD×0.095″ ID×0.5″ long, with 1 helical clutch tooth, 0.125″ deep×20° of hook with 140° of tooth thickness, designed to engage with the helical tooth on the mating part, which is part of the ladder rung support 223. The 20° of hook cause the clutch teeth to grip each other tighter as more weight is applied to the ladder rung support 223. While looking at FIG. 109, you can see the clutch teeth disengaged, the first knuckle on the left is welded to the hand truck attachment 222, the next knuckle to the right is welded to the ladder rung support 223, and so on.

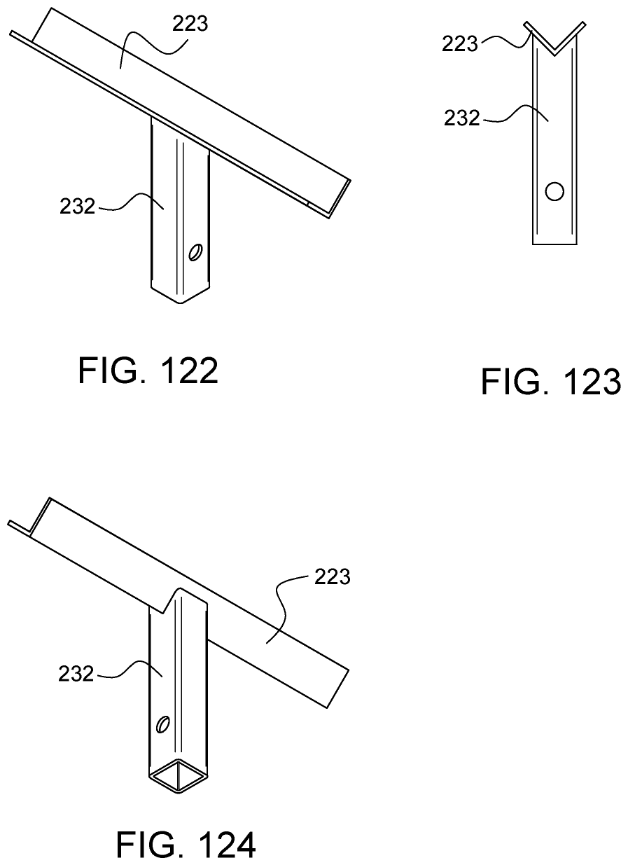

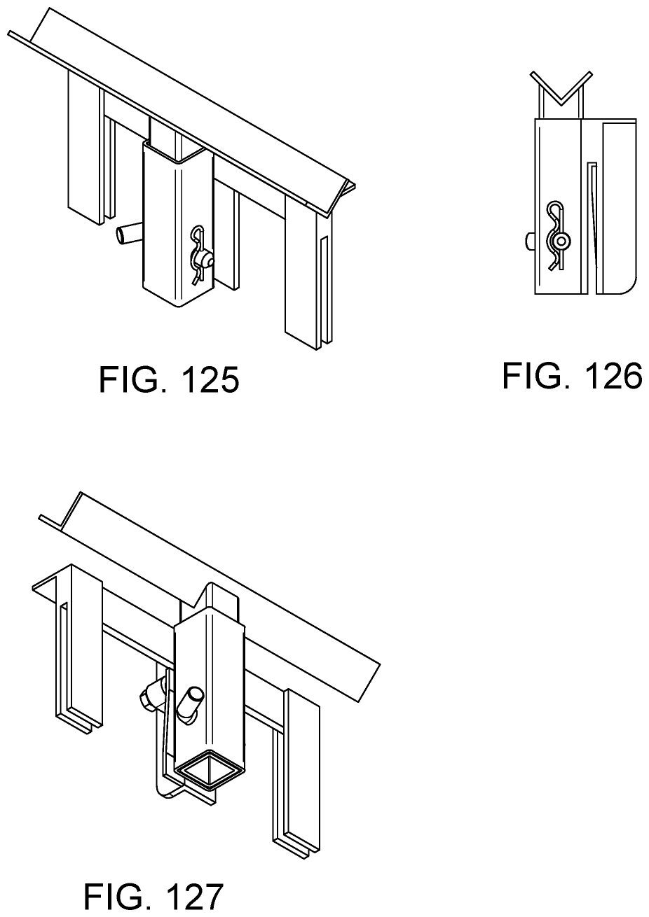

FIGS. 118-127 illustrate another embodiment of the adapter apparatus 221 and is removably installed. This embodiment includes an implement receiver 235 to allow swapping of different ladder supports. FIGS. 118-121 illustrate a base unit comprising an implement receiver 235, hand truck attachment 222, hitch pin 229, hair pin clip 230, and other components, which attach to a hand truck toe plate 202 and can accept various ladder support heads. The base unit comprising a horizontal frame made from 1.25″×1.25″×0.25″×11″ long angle iron with a vertical 1.25″×1.25″×0.125″×5″ long angle iron attached at the center inside corner. Each one of the two hand truck attachments 222 is made from 1.25″×0.75″×4″ long rectangle steel bar, slotted from the bottom, 3″ deep×0.25″ wide on center, one attached to a first end of the horizontal frame and the second one attached to a second end of the horizontal frame. The spring clamp 225 is made from 0.75″×0.125″×3″ long rectangle steel bar and is attached only at the bottom, uses spring tension to squeeze the hand truck toe plate 202, while the screw clamp 224 can apply additional clamping force to ensure the adapter apparatus 221 remains tightly attached when no ladder is being carried. The screw clamp 224 is a ⅜″-16 bolt screwed in to a threaded lug which is attached to the vertical 1.25″×1.25″×0.125″×5″ long angle iron with a 0.5″ radius on the bottom of one side. The implement receiver 235 is made from 1.5″ square outside dimension×0.095″ wall thickness×5″ long steel tube with a ½″ diameter hole through both sides, located 1.5″ from the bottom to accept hitch pin 229 which is locked in place by hair pin clip 230. The implement receiver 235 is attached to the center, outside corner of 11″ long horizontal angle iron, leaving a 0.25″ gap between itself and the vertical 1.25″×1.25″×0.125″×5″ long angle iron. FIGS. 122-124 illustrate the ladder rung support 223, with its support arm 232 which plugs in to the implement receiver 235. The ladder rung support 223 is made 1.25″×1.25″×0.125″×11″ long angle iron. The support arm 232 is made from 1.25″ square outside dimension×0.125″ wall thickness×6.5″ long steel tube with a ½″ diameter hole through both sides, located 1.5″ from the bottom to accept hitch pin 229 which is locked in place by hair pin clip 230. FIGS. 125-127 illustrate the ladder rung support 223 assembled to the base unit, removably held in place by the hitch pin 229 and hairpin clip 230.

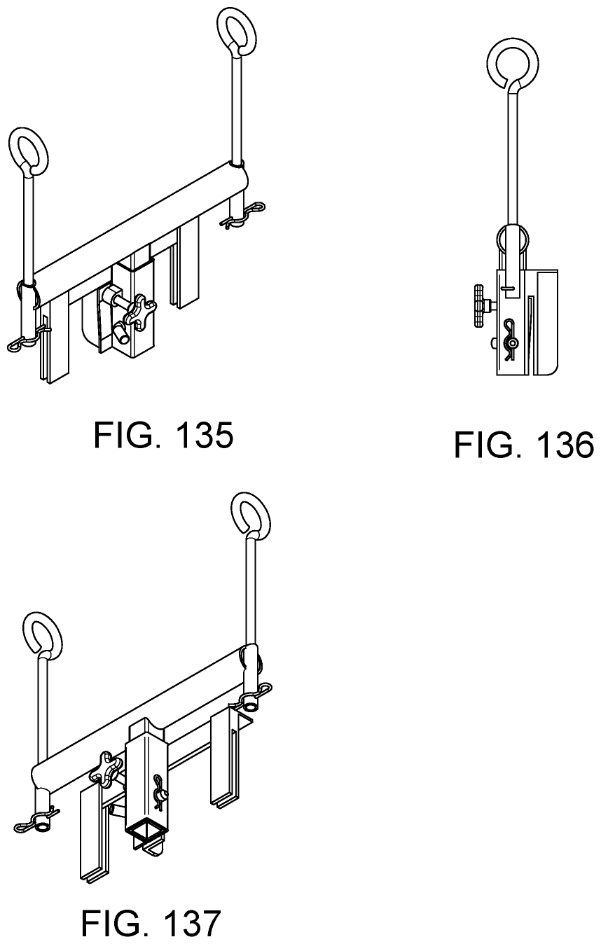

FIGS. 128-137 illustrate another embodiment of the adapter apparatus 221 and is removably installed. This embodiment includes an implement receiver 235 to allow swapping of different ladder supports. FIGS. 128-131 illustrate a base unit comprising an implement receiver 235, hand truck attachment 222, hitch pin 229, hair pin clip 230, and other components, which attach to a hand truck toe plate 202 and can accept various ladder support heads. The base unit comprising a horizontal frame made from 1.25″×1.25″×0.25″×11″ long angle iron with a vertical 1.25″×1.25″×0.125″×5″ long angle iron attached at the center inside corner. Each one of the two hand truck attachments 222 is made from 1.25″×0.75″×4″ long rectangle steel bar, slotted from the bottom, 3″ deep×0.25″ wide on center, one attached to a first end of the horizontal frame and the second one attached to a second end of the horizontal frame. The spring clamp 225 is made from 0.75″×0.125″×3″ long rectangle steel bar and is attached only at the bottom, uses spring tension to squeeze the hand truck toe plate 202, while the screw clamp 224 can apply additional clamping force to ensure the adapter apparatus 221 remains tightly attached when no ladder is being carried. The screw clamp 224 is a ⅜″-16 threaded rod with hand knob screwed in to a threaded lug which is attached to the vertical 1.25″×1.25″×0.125″×5″ long angle iron with a 0.5″ radius on the bottom of one side. The implement receiver 235 is made from 1.5″ square outside dimension×0.095″ wall thickness×5″ long steel tube with a ½″ diameter hole through both sides, located 1.5″ from the bottom to accept hitch pin 229 which is locked in place by hair pin clip 230. The implement receiver 235 is attached to the center, outside corner of 11″ long horizontal angle iron, leaving a 0.25″ gap between itself and the vertical 1.25″×1.25″×0.125″×5″ long angle iron. FIGS. 132-134 illustrate the horizontal ladder side rail support 226, with its support arm 232 which plugs in to the implement receiver 235. The horizontal ladder side rail support 226 is made from 1.5″ outside diameter×0.125″ wall thickness×14″ long round steel tubing with 0.375″ radius notch×0.375″ deep through both walls at both ends. The support arm 232 is made from 1.25″ outside dimension×0.125″ wall thickness×6.5″ long steel square tube with a ½″ diameter hole through both sides, located 1.5″ from the bottom to accept hitch pin 229 which is locked in place by hair pin clip 230. Each vertical ladder support 227 is removably attached to the horizontal ladder side rail support 226 by insertion in to a vertical ladder support socket 228 and held in place by hair pin 230 which pierces the vertical ladder support socket 228 and vertical ladder supports 227. A first vertical ladder support socket 228, made from 0.750″ outside diameter×0.120″ wall thickness×4″ long round steel tubing, top end is positioned flush with top of the first 0.375″ radius notch in the horizontal ladder side rail support 226 at one side of the device, then welded to the horizontal ladder side rail support 226. A second vertical ladder support socket 228 is positioned at the second end of the horizontal ladder side rail support 226, flush with the top, within the 0.375″ radius notch and then welded to the horizontal ladder side rail support 226. FIGS. 135-137 illustrate the horizontal ladder side rail support 226 assembled to the base unit, removably held in place by the hitch pin 229 and hairpin clip 230.

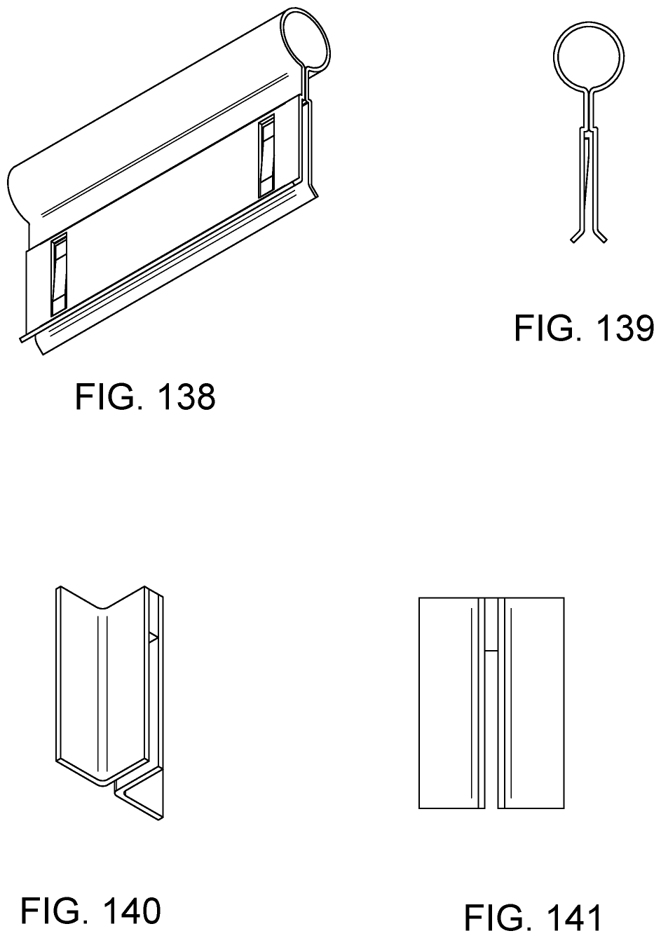

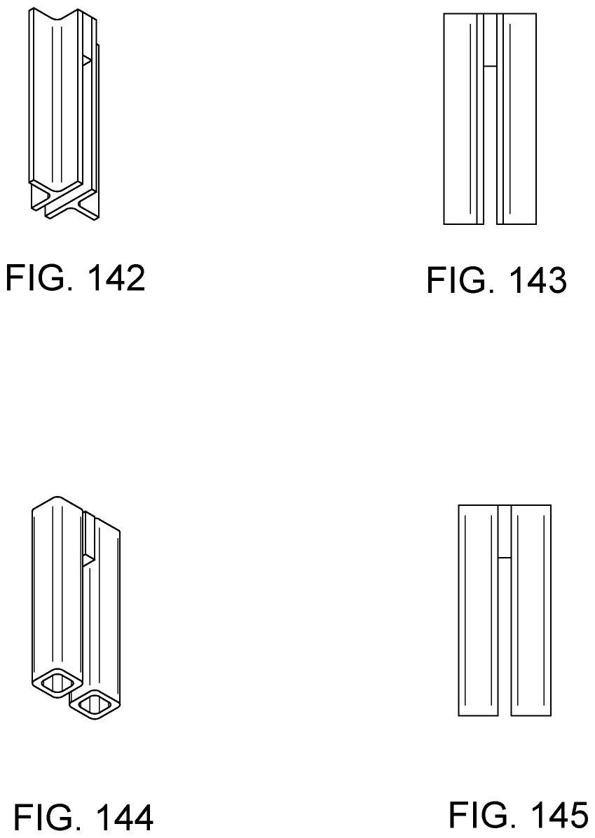

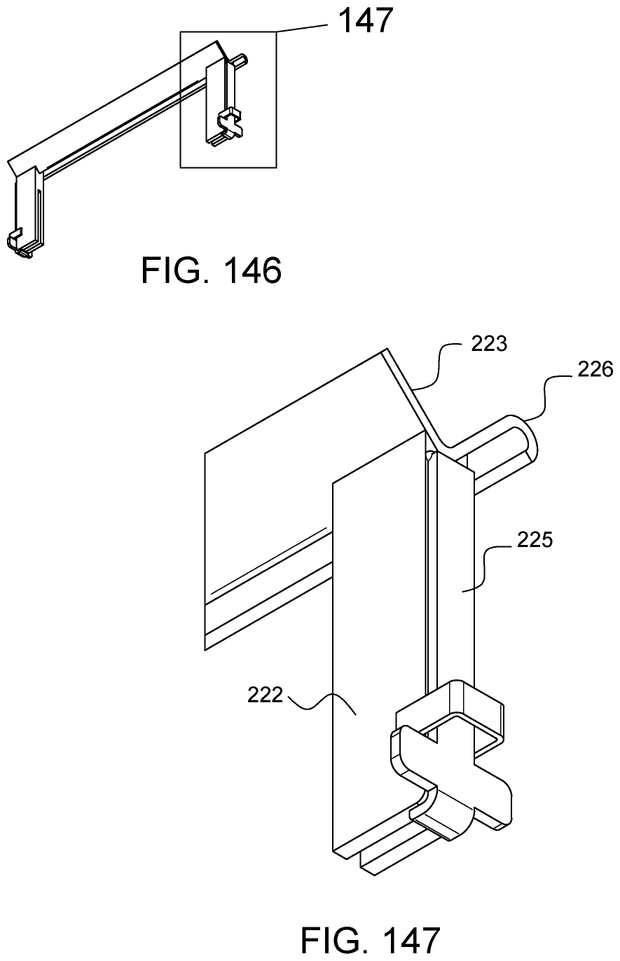

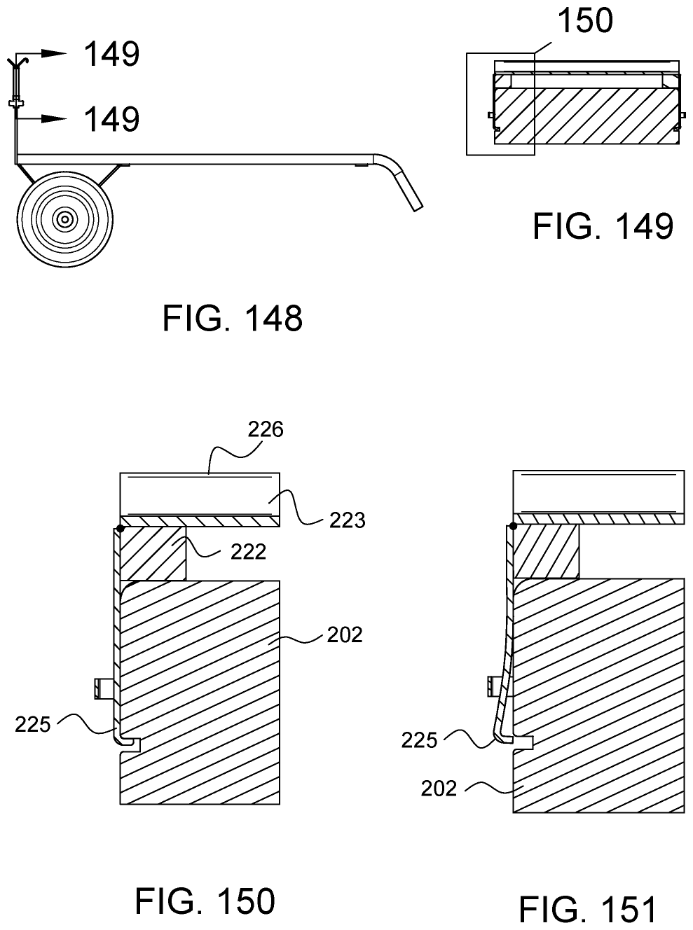

FIGS. 138-151 illustrate five different embodiments of the hand truck attachment 222 which could be substituted on previously shown adapter apparatuses 221. FIGS. 138-139 illustrate an embodiment of the adapter apparatus 221 and is removably installed, made with two die formed spring clamps 225 made from part of the hand truck attachment 222 sheet metal. FIGS. 140-141 illustrate an embodiment of the hand truck attachment 222 made from two pieces of 1.25″×0.125″ thickness×4″ long angle iron welded to each major face side of a 1.25″×0.250″ thickness×1″ long rectangle steel, producing a 0.250″ wide slot. FIGS. 142-143 illustrate an embodiment of the hand truck attachment 222 made from two pieces of 1.25″×0.125″ thickness×4″ long “T” angle iron welded to each major face side of a 1.25″×0.250″ thickness×1″ long rectangle steel, producing a 0.250″ wide slot. FIGS. 144-145 illustrate an embodiment of the hand truck attachment 222 made from two pieces of 0.75″×0.125″ thickness×4″ long square steel tubing welded to each major face side of a 1.25″×0.250″ thickness×1″ long rectangle steel, producing a 0.250″ wide slot. FIGS. 146-151 illustrate an embodiment of the adapter apparatus 221 with another embodiment of the hand truck attachment 222 and is removably installed by the manufacturer. This embodiment requires the manufacturer to slot the hand truck toe plate 202 in two places to accept engagement of a pawl at the lower end of the spring clamp 225. FIG. 146 illustrates the overall view of this embodiment. FIG. 147 illustrates the detail view of a hand truck attachment 222, spring clamp 225 with a “U” shaped strap welded near the lower end. The spring clamp 225 is made from 0.500″ wide×0.125″ thick×4.250″ long rectangle steel with two 0.500″ wide×0.500″ long ears near the bottom for grasping, 0.250 long pawl bent 90° at the lower end and the upper end is welded to the upper end of the hand truck attachment 222. The hand truck attachment 222 is made from 1.25″×0.75″×4″ long rectangle steel bar, slotted from the bottom, 3″ deep on center. The “U” shaped strap prevents the spring clamp 225 from over extension while the user is pulling the ears during pawl disengagement and removal from the hand truck toe plate 202. FIG. 148 illustrates the adapter apparatus mounted on a hand truck toe plate 202. FIG. 149 illustrates a cross section view of the adapter apparatus mounted on a hand truck toe plate 202. FIG. 150 illustrates a detail view of the cross-section view of FIG. 149, which shows the adapter apparatus mounted on a hand truck toe plate 202, while the spring clamp 225 is engaged with the slot in the hand truck toe plate 202. FIG. 151 illustrates a detail view of the cross-section view of FIG. 149, which shows the adapter apparatus mounted on a hand truck toe plate 202, while the spring clamp 225 is disengaged with the slot in the hand truck toe plate 202.

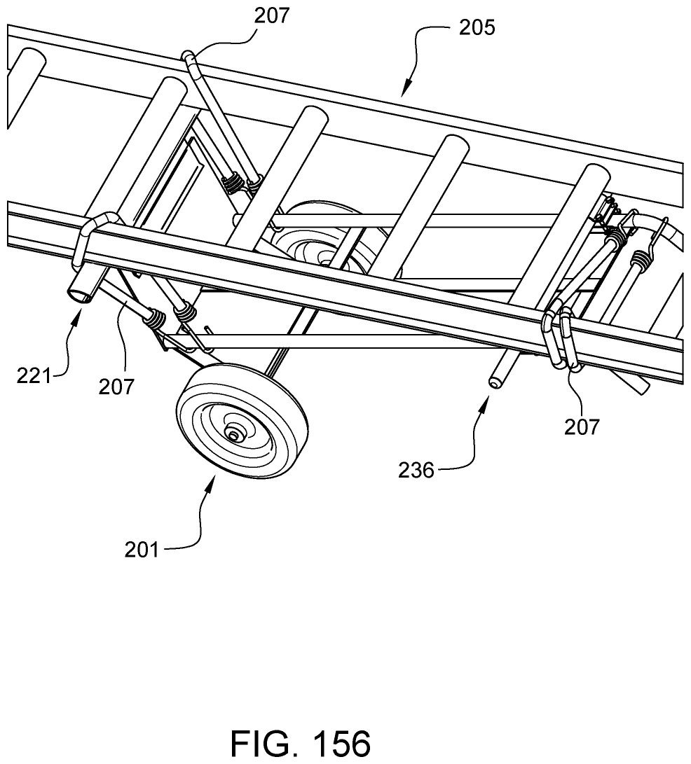

FIGS. 152-156 illustrate another embodiment of the adapter apparatus 221 and is removably installed. This embodiment includes a crossbar end support 236 which provides a second ladder support position which is removably mounted near the handle end of the hand truck 201. FIGS. 152-154 illustrate various views of the crossbar end support 236, where the 1″ outside diameter×0.125″ wall thickness×24″ long round tube attaches to the hand truck 201 frame using a pair of saddle clamps which make up the hand truck attachment 222. The 1″ round tube has a rounded plastic plug pressed in each end for safety and a nice appearance. The saddles are made from 2.500″ wide×3.187″ long×0.125″ thick sheet steel with a 0.500″ radius×0.500″ deep centered on the 2.500″ width center line, this produces a saddle measuring 2.500″×2.500″×0.625″ height. Drill 4 holes, 0.250″ diameter, 1.875″ square bolt hole pattern, through both saddles and the flat plate. All 3 saddle clamp components have a 0.250″ radius on each of the 4 corners. Each of the two saddle clamps uses 4 each, size ¼″-20 nuts & bolts to squeeze the assembly to the hand truck 201 frame. As an alternate means of attachment, the hand truck manufacturer could weld 2 separate 6″ lengths of 1″ round steel tube to each side of the hand truck frame, or they could weld one continuous 24″ length of 1″ round steel tube to the frame. Although not shown, foam rubber pipe insulation can also be slipped over the 1″ tube to cushion the ladder. FIG. 155 illustrates the adapter apparatus 221 and crossbar end support 236 attached to the hand truck 201 frame. FIG. 156 illustrates the adapter apparatus 221, crossbar end support 236, and single ladder 205 attached to the hand truck 201 using bungee straps 207. While we show only one ladder, multiple ladders can be carried simply by stacking them one on top of the other.

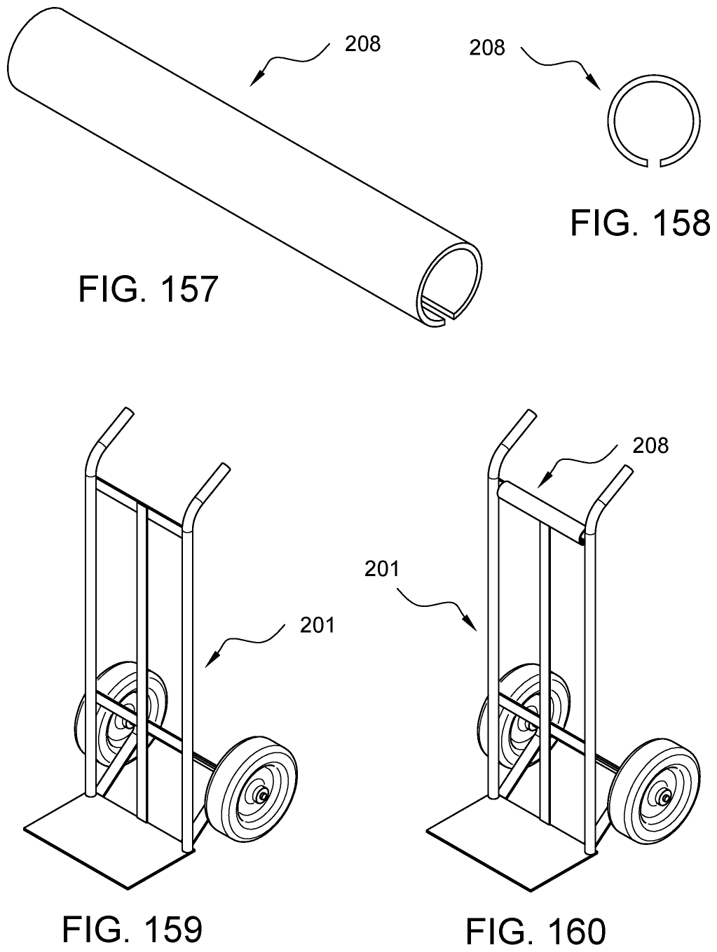

FIGS. 157-160 illustrate a crossbar cover 208 to protect the side rail of a ladder when it's carried on its side and hand truck 201 has ladder damaging edges on the crossbar. FIG. 157 illustrates the crossbar cover 208 in a perspective view. The crossbar cover 208 is made from 1.500″ schedule 40 PVC pipe with full length slot measuring 0.125″ wide which allows slipping over the rectangular crossbar of the hand truck 201, it then grips the vertical member welded to the crossbar. FIG. 158 illustrates the crossbar cover 208 in a side view. FIG. 159 illustrates a typical hand truck without the crossbar cover 208 attached. FIG. 160 illustrates the same hand truck with the crossbar cover 208 attached.

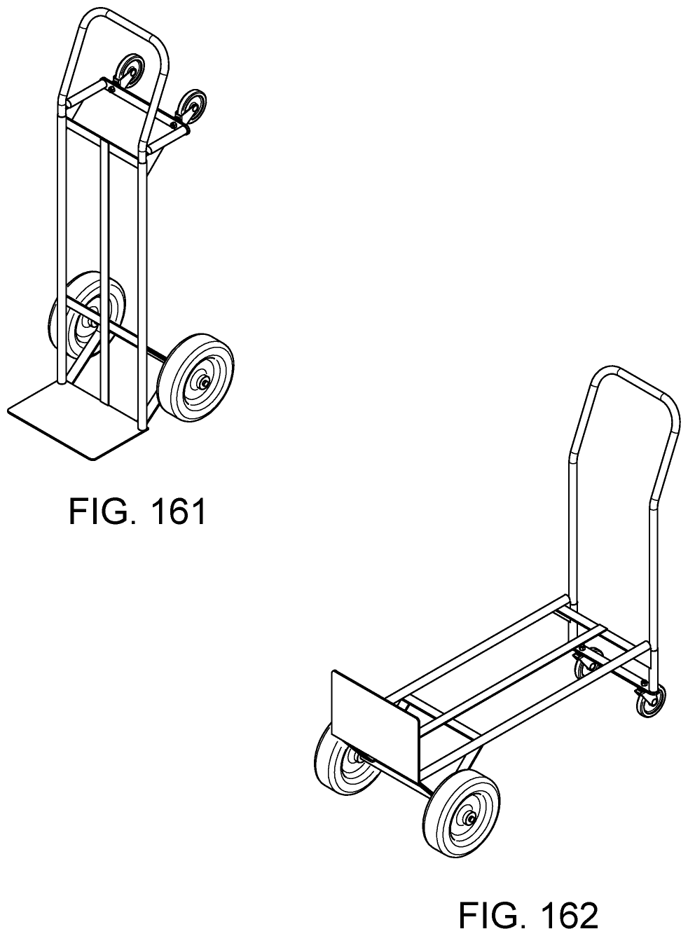

FIG. 161 illustrates a typical convertible hand truck, shown in hand truck mode. The adapter apparatus 221 works well with the convertible hand truck in this mode as well as the hand cart mode as shown FIG. 162.

FIG. 162 illustrates a typical convertible hand truck, shown in hand cart mode. The adapter apparatus 221 works well with the convertible hand truck in this mode as well as the hand truck mode as shown FIG. 161.

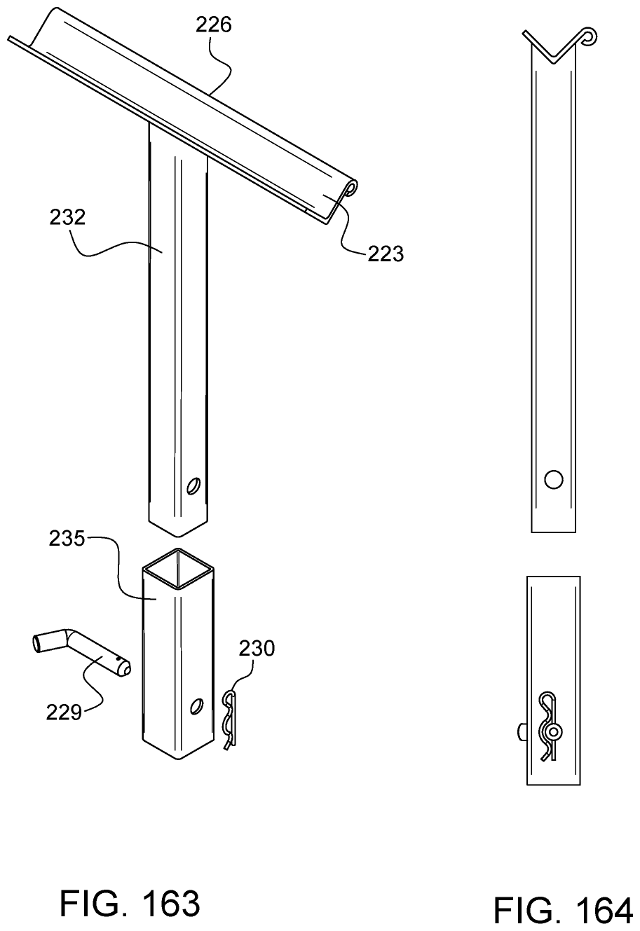

FIGS. 163-170 illustrate another embodiment of the adapter apparatus 221 and is installed by the manufacturer. This embodiment includes an implement receiver 235 to allow swapping of different ladder supports.

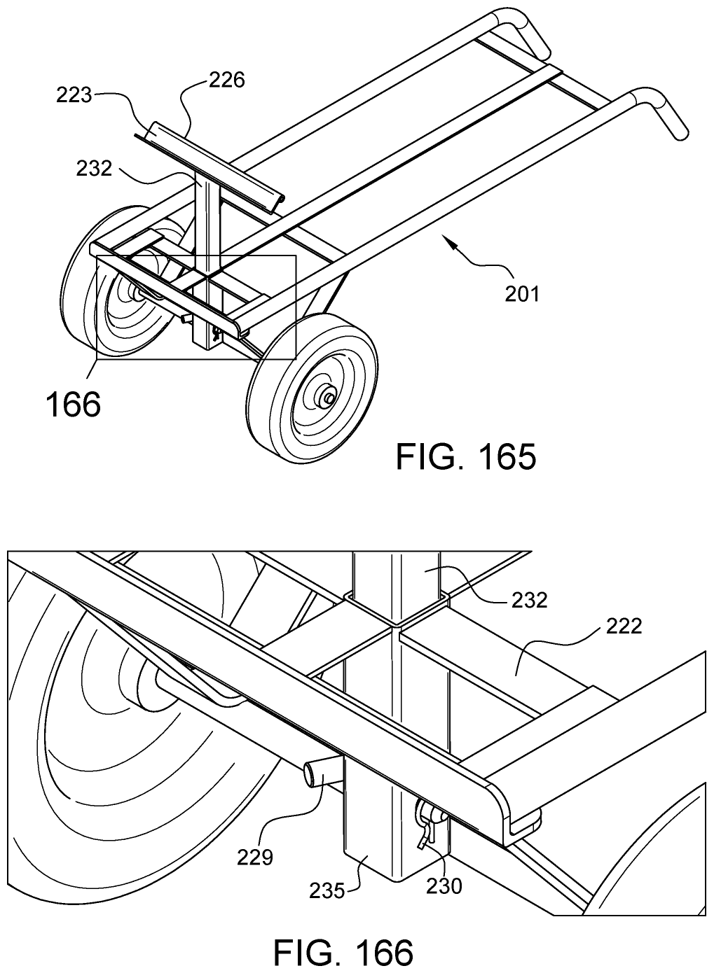

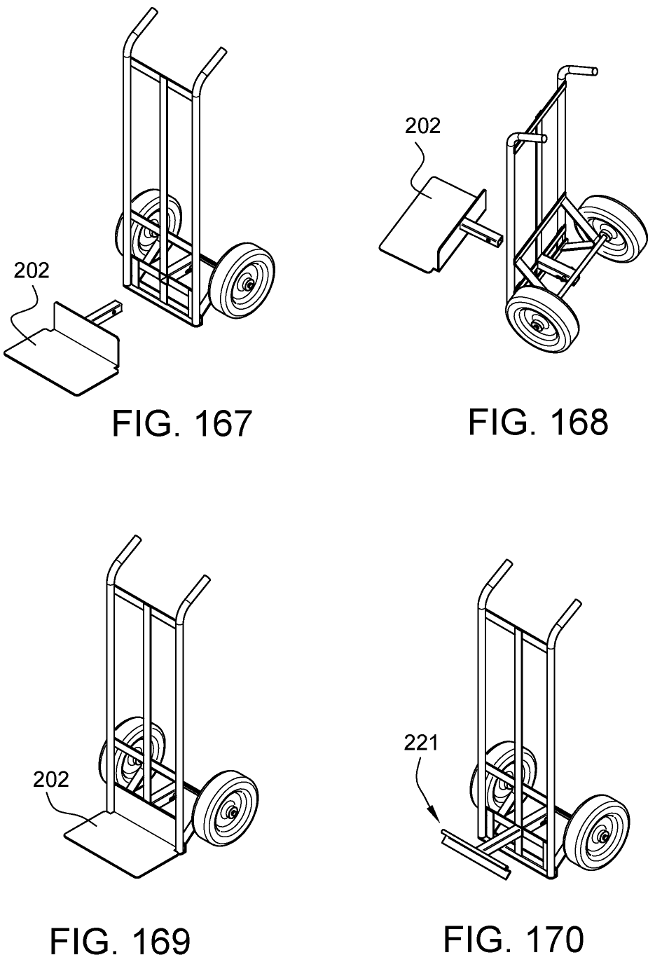

FIGS. 163-164 illustrate the multi-mode ladder support, with its support arm 232 which plugs in to the implement receiver 235. The multi-mode ladder support is made from 1.250″×2.250″×0.125″ thick by 11″ long angle iron with the tip of the 2.250″ leg bent into a 270° arc to form the horizontal ladder side rail support 226, while the inside angle is the ladder rung support 223. The support arm 232 is made from 1.25″ outside dimension×0.125″ wall thickness×14″ long steel square tube with a ½″ diameter hole through both sides, located 1.5″ from the bottom to accept hitch pin 229 which is locked in place by hair pin clip 230. The implement receiver 235 is made from 1.5″ square outside dimension×0.095″ wall thickness×5″ long steel tube with a ½″ diameter hole through both sides, located 1.5″ from the bottom to accept hitch pin 229 which is locked in place by hair pin clip 230. FIG. 165 illustrates the adapter apparatus 221 installed on a hand truck by the manufacturer. FIG. 166 is a detail view of FIG. 165, showing the implement receiver 235 welded to hand truck attachment 222 and the hand truck 201 axle. The hand truck attachment 222 is made from 1.250″ wide×0.187″ thick rectangle steel, the length is dependent on the manufacturers hand truck 201. FIGS. 167-168 illustrate the hand truck 201 with the hand truck toe plate 202 positioned in front of the hand truck 201 just before inserting in to the implement receiver 235. FIG. 169 illustrate the hand truck 201 with the hand truck toe plate 202 assembled to the implement receiver 235, removably held in place by the hitch pin 229 and hairpin clip 230. FIG. 170 illustrate the hand truck 201 with the adapter apparatus 221 assembled to the implement receiver 235, removably held in place by the hitch pin 229 and hairpin clip 230.

FIG. 171 illustrates the adapter apparatus 221 attached to a hand truck 201, supporting a single ladder 205 being pulled by a man. The center of the single ladder 205 is positioned directly over the hand truck 201 wheels which support nearly all of the weight, allowing the user to easily transport the ladder. Additional ladders and equipment can be stacked on top the first ladder.

FIGS. 172-173 illustrate the adapter apparatus 221 attached to a wheel barrow type hand truck 201. The ladder will be centered over the single wheel and attached with bungee straps.

It will be understood that each of the elements described above, or two or more together, may also find a useful application in other types of constructions differing from the types described above.

While an adapter apparatus has been illustrated and described as embodiments of an adapter apparatus accessory for a hand truck, accordingly it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

What is claimed is:

1. An adapter apparatus for transporting a ladder with a hand truck of the type having wheels, the apparatus comprising:
a ladder support configured for receiving a portion of a ladder thereof; and
at least one hand truck attachment configured for engageably receiving a toe plate of the hand truck;
wherein a first end of the at least one hand truck attachment is coupled to the ladder support;
wherein a second opposing end of the at least one hand truck attachment is configured for securely engaging the toe plate of a hand truck;
whereby at least a portion of a weight of the ladder is transferred onto the toe plate of the hand truck when the ladder is transported on the hand truck with the ladder support contacting the ladder thereof.

2. The apparatus of claim 1, wherein the at least one hand truck attachment comprises two hand truck attachments that removably attach to the toe plate of the hand truck.

3. The apparatus of claim 1, wherein the at least one hand truck attachment comprises two clip members that removably slide into the toe plate of the hand truck.

4. The apparatus of claim 1, wherein the at least one hand truck attachment comprises two rods pivotably attached to a main frame of the hand truck through a hitch pin arrangement.

5. The apparatus of claim 1, wherein the at least one hand truck attachment comprises two rods pivotably attached to the toe plate through a hitch pin arrangement.

6. The apparatus of claim 1, wherein the at least one hand truck attachment comprises a screw clamp for securing the at least one hand truck attachment to the toe plate by tightening of the screw clamp.

7. The apparatus of claim 1, wherein the at least one hand truck attachment comprises a spring clamp for securing the at least one hand truck attachment to the toe plate by spring action of a resilient member of the spring clamp.

8. The apparatus of claim 1, wherein the at least one hand truck attachment comprises: a screw clamp for securing the at least one hand truck attachment to the toe plate by tightening of the screw clamp; and, a spring clamp for securing the at least one hand truck attachment to the toe plate by spring action of a resilient member of the spring clamp.

9. The apparatus of claim 1, wherein the at least one hand truck attachment is removably coupled to the ladder support.

10. The apparatus of claim 1, wherein the at least one hand truck attachment is permanently coupled to the ladder support.

11. The apparatus of claim 1, wherein the at least one hand truck attachment and the ladder support are of single continuous construction to form a single unit.

12. The apparatus of claim 1, wherein the ladder support has a profile that does not extend beyond a free end of the toe plate.

13. The apparatus of claim 1, further comprising a crossbar cover for sliding over a topmost crossbar of the hand truck.

14. The apparatus of claim 1, wherein the at least one hand truck attachment is further configured for sliding over a side wall of wheelbarrow.

15. A method of transporting a ladder with a hand truck of the type having wheels, the method comprising:
providing an adapter apparatus comprising:
a ladder support configured for receiving a portion of a ladder thereof; and
at least one hand truck attachment configured for engageably receiving a toe plate of the hand truck;
wherein a first end of the at least one hand truck attachment is coupled to the ladder support;
wherein a second opposing end of the at least one hand truck attachment is configured for securely engaging a toe plate of a hand truck;
whereby at least a portion of a weight of the ladder is transferred onto the toe plate of the hand truck when the ladder is transported on the hand truck with the ladder support contacting the ladder thereof
positioning a portion of the ladder on the ladder support;
adjusting a disposition of the hand truck such that the ladder is off ground;
moving the hand truck such that the ladder is transported from a first location to a second location.

16. The method of claim 15, wherein the ladder support comprises a bar insertable through a hollow rung of the ladder, wherein the method further comprises inserting the bar through the hollow rung of the ladder.

17. The method of claim 15, wherein the ladder support comprises a cradle configured for receiving a rung of the ladder therein, wherein the method further comprises receiving the rung of the ladder by the cradle.

18. The method of claim 15, wherein the adapter apparatus further comprises a pair of vertical members for receiving a side rail of the ladder therebetween, wherein the method further comprises placing a side rail of the ladder between the vertical members.

19. The method of claim 15, further comprising removably coupling the at least one hand truck attachment to the ladder support.

20. The method of claim 15, further comprising permanently coupling the at least one hand truck attachment to the ladder support.
